(19) United States
(12) Patent Application Publication
(10) Pub. No.: US 2025/0336266 A1
(43) Pub. Date: Oct. 30, 2025

(54) SYSTEMS AND METHODS FOR PASSIVE NFC-ENABLED GAMING TABLE TRANSACTIONS

(71) Applicant: Walker Digital Table Systems, LLC, Las Vegas, NV (US)

(72) Inventor: Stephen Moore, Las Vegas, NV (US)

(21) Appl. No.: 19/260,604

(22) Filed: Jul. 6, 2025

Related U.S. Application Data
(63) Continuation of application No. PCT/US2025/020474, filed on Mar. 18, 2025.
(60) Provisional application No. 63/566,859, filed on Mar. 18, 2024.

(51) Int. Cl. G07F 17/32; G06Q 20/20; G06Q 20/32; G06Q 50/34

(52) U.S. Cl. CPC G07F 17/322; G06Q 20/204; G06Q 20/3278; G06Q 50/34; G07F 17/323; G07F 17/3239; G07F 17/3255; G07F 17/3288

(57) ABSTRACT

Systems and methods for passive NFC-enabled gaming transactions at a gaming table. In some embodiments, a gaming table includes an NFC tag at one or more player positions. A player playing at the one or more player positions can initiate gaming sessions or transactions, or accept offers, by scanning the NFC tag.

### CROSS REFERENCE AND CLAIM OF PRIORITY TO RELATED APPLICATION(S)

The present application claims priority to, and the benefit of, PCT Application No. PCT/US25/020474, filed on Mar. 18, 2025 in the name of Stephen Moore and titled SYSTEMS AND METHODS FOR PASSIVE NFC-ENABLED GAMING TABLE TRANSACTIONS, which PCT Application claims priority to U.S. provisional patent Application Ser. No. 63/566,859, filed Mar. 18, 2024 filed in the name of Stephen Moore and titled SYSTEMS AND METHODS FOR PASSIVE NFC-ENABLED GAMING TABLE TRANSACTIONS. The entire contents of each of these Applications are hereby incorporated herein by reference for all purposes.

### BACKGROUND

Transactions involving short-range radio communications such as those that employ Near-Field Communication (NFC) receivers and transmitters have been utilized in various consumer environments, particularly for wireless or “contactless” payment transactions. Many credit cards and smart phones have been outfitted with passive NFC transmitters that, when introduced to a magnetic field of an NFC interrogation, receiver, or “reader” device, provide payment information that is utilized to conduct a payment transaction, e.g., with a Point-of-Sale (PoS) that is interfaced with the NFC receiver. Applicant has developed an application utilizing an NFC tag that is combined with RFID technology for enabling transactions, events and rewards at a gaming table.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1 is a block diagram of a system according to some embodiments;

FIG. 2A is a block diagram of a gaming table system according to some embodiments;

FIG. 2B is an example felt layout of a gaming table system according to some embodiments;

FIG. 3 is a block diagram of a system according to some embodiments;

FIG. 4 is a flow diagram of a method according to some embodiments;

FIG. 5 is a block diagram of an apparatus according to some embodiments;

FIG. 6A, FIG. 6B, FIG. 6C, FIG. 6D, and FIG. 6E are perspective diagrams of exemplary data storage devices according to some embodiments;

FIG. 7 is flowchart of an process according to some embodiments;

FIG. 8 is a perspective view of an NFC tag package, in accordance with some embodiments described herein;

FIG. 9 is a flowchart of a process for registering NFC tags according to some embodiments;

FIGS. 10A-10C are a series of screens or GUIs that may be output to an administrator or other user during an NFC tag registration process, such as the one illustrated in FIG. 9;

FIG. 11 is a flowchart of a process for a player to clock in at a particular player position according to some embodiments; and

FIGS. 12A-12C are a series of screens or GUIs that may be output to a player participating in the process of FIG. 10.

### DETAILED DESCRIPTION

### I. Introduction

Short-range radio communications have also been utilized in the gaming industry such as by tracking, counting, and authenticating casino wagering chips, e.g., “smart chips”. The most advanced physical gaming devices such as electronically-enabled or “smart” gaming tables are outfitted with an array of Radio Frequency IDentification (RFID) reader/receiver/interrogation equipment such as various antenna, processing devices, and data storage devices. Such systems are necessarily expensive to configure and install, however, and require a significant amount of space (on a gaming table that has limited space available) and electrical power. Nevertheless, the many advantages provided by such systems where large numbers of smart chips must be frequently interrogated to accomplish gaming-related tasks for any particular game, have proven their worth.

Applicant (through the inventive effort of the named inventors) has realized that incorporating Near Field Communication (NFC) technology into an RFID-enabled table would allow additional advantages, benefits and efficiencies not readily available in an RFID-only table. For example, an RFID/NFC-enabled gaming table that operates in reverse to the typical NFC/RFID paradigm for certain transactions may be advantageous and may improve previous systems. In accordance with embodiments herein, for example, systems, methods, and articles of manufacture for NFC-enabled gaming table transactions are provided that enable: (i) identification of a particular player situated at a particular player station of a gaming table, (ii) identification of the particular player situated at a particular betting location of the gaming table, (iii) identification of an account number of the particular player, (iv) automatic clock-in of the particular player into a gaming session of the gaming table, (v) automatic transmission of data descriptive of the particular player to a dealer of the gaming table, (vi) automatic determination of a wager amount for the particular player in a gaming session of the gaming table, (vii) identification of a purchase order for the particular player, (viii) identification of payment information for the particular player, (x) real-time offers being output to, and accepted by, a player (and gaming currency, whether physical or digital, being readily provided to the player by a dealer upon acceptance of some such offers), and/or (x) automatic delivery of a purchased product to the particular player station where the particular player is disposed.

According to some embodiments, any or all of such features may be effectuated utilizing a plurality of low-cost NFC transmitters or “tags” affixed to the gaming table, in concert with an NFC receiver of a player device such as may be incorporated into a smart phone of the player. In some embodiments, such an NFC tag may be a combination RFID/NFC tag that incorporates both NFC and RFID technology into a single disc or tag that is affixed (e.g., under the felt) to a table. As the NFC receiver equipment is significantly more expensive and also an active consumer of electrical power, some embodiments reverse the typical “smart table” setup by relying on the player (consumer, customer, client, etc.) to provide the NFC receiver equipment (e.g., the “active” equipment) while the gaming table may be outfitted with a plurality of low-cost, low (or no) power consuming, and easily concealed NFC tags. In such a manner, for example, a gaming table may be configured to enable and/or effectuate embodiments herein for mere dollars in additional cost (e.g., “passive” NFC tags may be obtained for less than fifty cents ($0.50) per unit), while the more expensive (in terms of cost, form factor, and power consumption) active NFC equipment that is already owned by players may be effectively leveraged to provide enhanced functionality to the gaming table (and/or game sessions thereof).

### II. Passive NFC-Enabled Gaming Table Systems

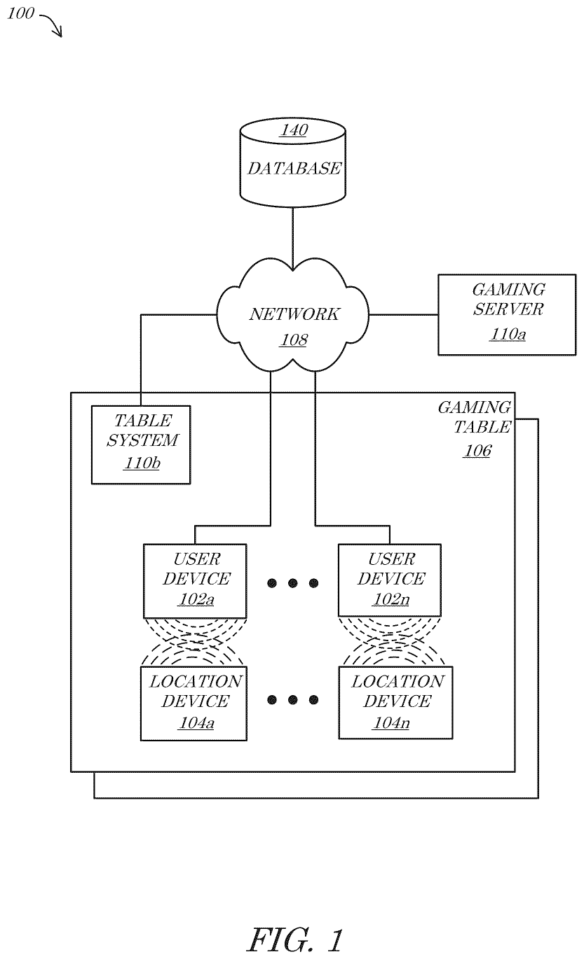

Referring first to FIG. 1, a block diagram of a system 100 according to some embodiments is shown. In some embodiments, the system 100 may comprise a plurality of user devices 102a-n in communication with a plurality of location devices 104a-n. In some embodiments, the user devices 102a-n and/or the location devices 104a-n may comprise and/or be disposed on (or at) one or more gaming tables 106. According to some embodiments, the gaming table 106 (and/or the user devices 102a-n and/or the location devices 104a-n thereof) may be in communication, via a network 108, with a gaming server 110a. According to some embodiments, the gaming table 106 may comprise a table server or system 110b. In some embodiments, the system 100 may comprise and/or any or all of the devices 102a-n, 104a-n, 106, 110a-b may comprise and/or be in communication with a data storage device, memory device, and/or database 140. According to some embodiments, communications between and/or within the devices 102a-n, 104a-n, 106, 110a-b, 140 of the system 100 may be utilized to: (i) identify a particular player situated at a particular player station and/or betting spot of the gaming table 106 (e.g., identify a first user device 102a in communication with a first location device 104a), (ii) identify an account number of the particular player (e.g., by accessing the database 140), (iv) automatically clock-in the particular player into a gaming session of the gaming table 106 (e.g., by execution of game instructions (not shown) by the table system 110b), (v) automatically transmit data descriptive of the particular player to a dealer and/or dealer device (not separately shown) of the gaming table 106, (vi) automatically determine a wager amount for the particular player in a gaming session of the gaming table 106, (vii) identify a purchase order for the particular player, (viii) identify payment information for the particular player, (x) output offers to a particular player via a user device 102a-n and/or recognize an acceptance of an offer by a particular player when the player scans or taps a particular location device 104a-n of the table; and/or (x) automatically deliver a purchased product (not shown) to the particular player station where the particular player is disposed.

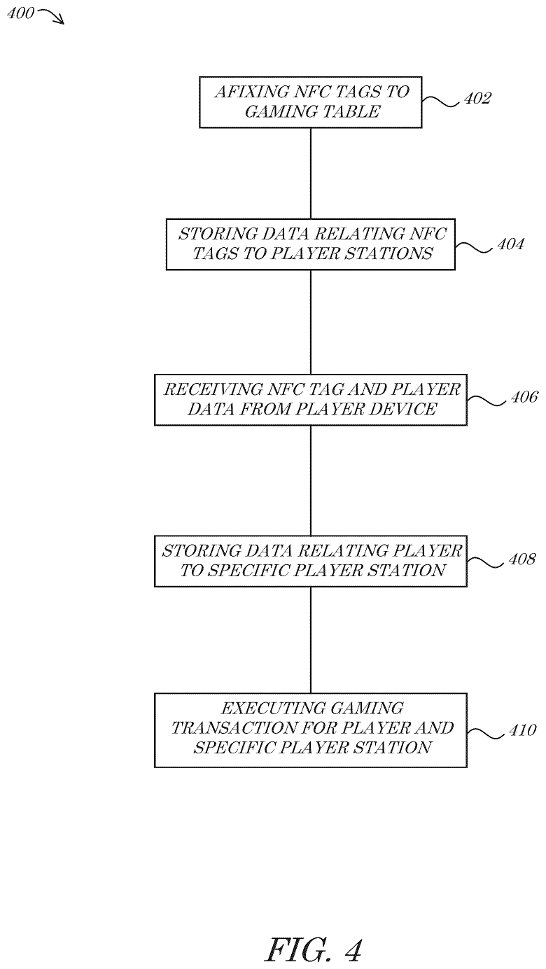

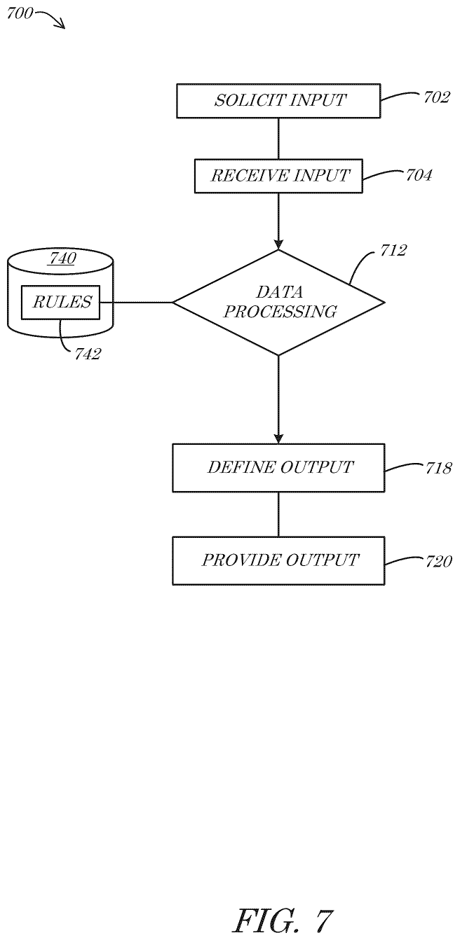

Fewer or more components 102a-n, 104a-n, 106, 108, 110a-b, 140 and/or various configurations of the depicted components 102a-n, 104a-n, 106, 108, 110a-b, 140 may be included in the system 100 without deviating from the scope of embodiments described herein. In some embodiments, the components 102a-n, 104a-n, 106, 108, 110a-b, 140 may be similar in configuration and/or functionality to similarly named and/or numbered components as described herein. In some embodiments, the system 100 (and/or portions thereof) may comprise a passive NFC-enabled gaming system and/or a platform programmed and/or otherwise configured to execute, conduct, and/or facilitate the methods/algorithms 400, 700 of FIG. 4 and/or FIG. 7 herein, and/or portions or combinations thereof.

According to some embodiments, the user devices 102a-n may comprise any type or configuration of computing, mobile electronic, network, client, and/or communication devices that are or become known or practicable. The user devices 102a-n may, for example, comprise one or more “smart” and/or cellular and/or wireless telephones, such as an iPhone® (manufactured by Apple®, Inc.) or an LG V50 THINQ™ 5G smart phone manufactured by LG® Electronics, Inc. of San Diego, CA, and running the Android® operating system from Google®, Inc. of Mountain View, CA. In some embodiments, the user devices 102a-n may comprise one or more devices owned and/or operated by one or more wagering game players (or potential customers; none of which are shown), such as casino customers and/or players attempting to clock-in and/or order a product or service at the gaming table 106. In some embodiments, a user device 102a-n may comprise a proprietary handheld device provided by a wagering establishment to a player for use with wagering games within the wagering establishment. According to some embodiments, the user devices 102a-n may comprise active NFC electronics, hardware, and/or software (not separately shown) to communicate with one or more of the location devices 104a-n. The user devices 102a-n may, for example, obtain location-specific information such as bet spot and/or player station/seat location or position information from the location devices 104a-n and transmit the location information and player data (e.g., player account and/or identification information) to the gaming server 110a and/or the table system 110b.

In some embodiments, the location devices 104a-n may comprise any type or configuration of computing, mobile electronic, network, client, and/or communication devices that are operable to facilitate discrete location determination and are or become known or practicable. The location devices 104a-n may, for example, comprise one or more passive NFC tags such as a twenty-five millimeter (25-mm) circle or ten by ten millimeter (10×10- mm) square shape antenna format with an embedded NTAG213™ microchip available from NXP® Semiconductors of Eindhoven, Netherlands. In some embodiments, the location devices 104a-n may be configured to operate and/or communicate in accordance with one or more protocols and/or standards such as the ISO 14443-A standard published by the ISO/IEC JTC 1 (Joint Technical Committee 1)/SC 17 (Subcommittee 17)/WG 8 (Working Group 8) on Dec. 12, 2018, and/or the NFC Forum Type 1, Type 2, Type 3, Type 4, or Type 5 published by the NFC Forum of Wakefield, MA. In some embodiments, the location devices 104a-n may be configured to be activated, interrogated, powered, and/or otherwise placed into communication via signals tuned to a frequency of thirteen and fifty-six hundredths mega Hertz (13.56 MHZ) and/or may be programmed for Phase-Jitter Modulation (PJM). Any location device 104a-n may comprise multiple distinct components (not separately shown) such as, but not limited to, (i) a substrate (e.g., a housing, frame, or base material), (ii) an antenna (e.g., that is responsive to an active energy field to communicate data wirelessly from the location device 104a-n and/or to provide power to the location device 104a-n), and (iii) a micro-chip (e.g., that stores data, such as player station, bet spot, and/or other gaming-related discrete location data).

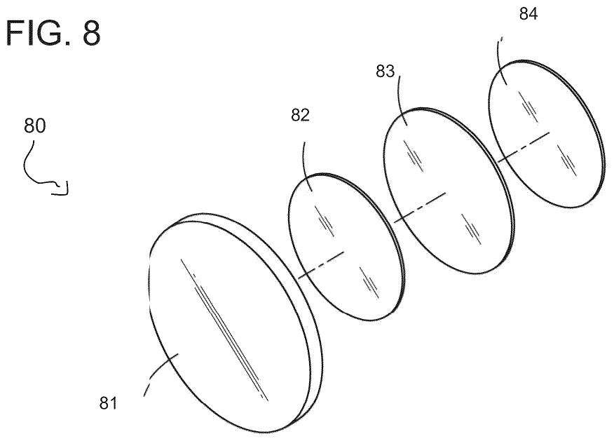

In some embodiments, a location device 104a-n may comprise a tag or packaging comprising a combination of RFID technology (e.g., PJM) and NFC technology (sometimes referred to as a “combination tag” herein). In some embodiments, a location device 104a-n may comprise an NFC tag and/or an RFID/PJM inlay packaged as a single item or into a protective casing or body, for ease of application or other benefits (referred to as an NFC tag package herein). An example of an NFC tag package design is illustrated in FIG. 8. It should be understood that whenever a reference is made herein to an NFC tag or a location device 104a-n, such reference may be equally applicable to such a combination tag or an NFC tag package (unless specified otherwise).

According to some embodiments, the gaming table 106 may comprise any type and/or configuration of physical gaming structure, surface, and/or object that is facilitated and/or controlled by the table system 110b. The gaming table 106 may comprise, for example, a “smart” table comprising various gaming features (not shown) such as felt, graphics, wheels, card shoes, chip trays, etc. arranged, disposed, and/or coupled to a gaming structure such as an actual table or other physical object. According to some embodiments, the gaming table 106 may comprise a table configured for play of various wagering and/or casino games such as baccarat, blackjack, roulette, craps, Sic Bo, Pai Gow (tile and poker variations), LET IT RIDE™, CARIBBEAN STUD™, 3-CARD POKER, 4-CARD POKER, SPANISH 21, and/or variants of such games (e.g., Chemin de Fer), and the like. In some embodiments for example, the gaming table 106 may comprise a “smart” baccarat table utilizing the Perfect Play® electronic gaming system (e.g., the table system 110b) powered by PJM3.0™ and available from Walker Digital Table Systems (WDTS), LLC of Las Vegas, NV. Non-limiting examples of some suitable gaming tables that may embody gaming table 106 (albeit with the NFC technology described herein being added thereto) are described in commonly owned U.S. Pat. No. 9,694,272 titled RFID-ENABLED SYSTEMS FOR FACILITATING TABLE GAMES, U.S. Pat. No. 10,755,520 titled SYSTEMS AND METHODS FOR UTILIZING RFID TECHNOLOGY TO FACILITATE A GAMING SYSTEM, and U.S. Pat. No. 11,875,641 titled SYSTEMS AND METHODS FOR INFERRING TRANSACTION BASED ON DATA DETECTED FROM RFID ELEMENTS AT SMART GAME TABLE. The entirety of each of these patents, and particularly the RFID-enabled table game system configurations and elements thereof, are hereby incorporated by reference herein.

The network 108 may, according to some embodiments, comprise a Local Area Network (LAN; wireless and/or wired), cellular telephone, Bluetooth®, NFC, and/or Radio Frequency (RF) network with communication links between the gaming server 110a, table system 110b, the user devices 102a-n, the location devices 104a-n, and/or the database 140. In some embodiments, the network 108 may comprise direct communication links between any or all of the components 102a-n, 104a-n, 106, 110a-b, 140 of the system 100. The user devices 102a-n may, for example, be directly interfaced or connected to one or more of the gaming server 110a and/or the table system 106 via one or more wires, cables, wireless links, and/or other network components, such network components (e.g., communication links) comprising portions of the network 108. In some embodiments, the network 108 may comprise one or many other links or network components other than those depicted in FIG. 1. The gaming server 110a may, for example, be connected to one or more of the user devices 102a-n via various cell towers, routers, repeaters, ports, switches, and/or other network components that comprise the Internet and/or a cellular telephone (and/or Public Switched Telephone Network (PSTN)) network, and which comprise portions of the network 108.

While the network 108 is depicted in FIG. 1 as a single object, the network 108 may comprise any number, type, and/or configuration of networks that is or becomes known or practicable. According to some embodiments, the network 108 may comprise a conglomeration of different sub-networks and/or network components interconnected, directly or indirectly, by the components 102a-n, 104a-n, 106, 110a-b, 140 of the system 100. The network 108 may comprise one or more cellular telephone networks with communication links between the user devices 102a-n and the gaming server 110a, for example, and/or may comprise an NFC or other short-range wireless communication path, with communication links between various user devices 102a-n and/or location devices 104a-n, for example.

In some embodiments, the gaming server 110a may comprise an electronic and/or computerized controller device, such as a computer server and/or server cluster communicatively coupled to interface with the user devices 102a-n and/or the table system 110b (directly and/or indirectly). The gaming server 110a may, for example, comprise one or more PowerEdge™ M910 blade servers manufactured by Dell®, Inc. of Round Rock, TX, which may include one or more Eight-Core Intel® Xeon® 7500 Series electronic processing devices. According to some embodiments, the gaming server 110a may be located remotely from one or more of the user devices 102a-n and/or the gaming table(s) 106. The gaming server 110a may also or alternatively comprise a plurality of electronic processing devices located at one or more various sites and/or locations (e.g., a distributed gaming, computing, a “cloud computing” and/or processing network).

According to some embodiments, the gaming server 110a may store and/or execute specially programmed instructions (not separately shown in FIG. 1) to operate in accordance with embodiments described herein. The gaming server 110a may, for example, execute one or more programs, modules, models, and/or routines (e.g., gaming programs) that operate to process data in the furtherance of various procedures such as, but not limited to, conducting wagering games, processing wagers, computing player loyalty and/or expected value metrics, outputting offers to players and/or detecting an acceptance of an offer by a player, and processing service and/or product transactions at (or within) a gaming establishment (e.g., a Class III Gaming establishment such as a casino operated in accordance with 25 CFR § 502.4).

In some embodiments, the table system 110b may comprise a plurality of communicatively coupled electronic and/or computerized processing devices, display devices, sensors, and/or memory devices coupled to and/or assigned to a particular gaming table 106 and/or game operated thereon. According to some embodiments, the table system 110b may comprise various hardware and software components (not separately shown in FIG. 1) operable to execute and/or conduct a gaming session at the gaming table 106. In some embodiments, the table system 110b may function in concert with and/or be part of the gaming server 110a. According to some embodiments, the table system 110b may be located remotely from the gaming table 106 or may be coupled to and/or embedded within the gaming table 106.

According to some embodiments, the gaming server 110a and/or the table system 110b may store (e.g., in the database 140) and/or execute specially programmed instructions (not separately shown in FIG. 1) to operate in accordance with embodiments described herein. The gaming server 110a and/or the table system 110b may, for example, execute one or more programs, modules, models, and/or routines (e.g., Artificial Intelligence (AI) and/or Machine Learning (ML)) that passive NFC-enabled gaming table transaction processing functionality, as described herein. According to some embodiments, the gaming server 110a and/or the table system 110b may execute stored instructions, logic, and/or software modules and/or models to: (i) identify a particular player situated at a particular player station and/or betting spot of the gaming table 106 (e.g., identify a first user device 102a in communication with a first location device 104a), (ii) identify an account number of the particular player (e.g., by accessing the database 140), (iv) automatically clock-in the particular player into a gaming session of the gaming table 106 (e.g., by execution of game instructions (not shown) by the table system 110b), (v) automatically transmit data descriptive of the particular player to a dealer and/or dealer device (not separately shown) of the gaming table 106, (vi) automatically determine a wager amount for the particular player in a gaming session of the gaming table 106, (vii) identify a purchase order for the particular player, (viii) identify payment information for the particular player, (ix) automatically determine that a player has accepted an offer output to the player via an App on a user device 102a and provide a benefit of the offer to the player via the App or by instructing a dealer of the table 106, and/or (x) automatically deliver a purchased product (not shown) to the particular player station where the particular player is disposed.

In some embodiments, the user devices 102a-n, the gaming server 110a, and/or the table system 110b may be in communication with and/or comprise the memory device 140. The memory device 140 may comprise, for example, various databases and/or data storage mediums that may store, for example, location device 104a-n data, account data, tax data, business data, image data, variable data, statistical data, sensor data, parameter value identification rules, object data, classification rules, keyword identification rules, GUI element data, natural text generation data, Optical Character Recognition (OCR) rules and/or data, cryptographic keys and/or data, login and/or identity credentials, and/or instructions (e.g., gaming rules) that cause various devices (e.g., the gaming server 110a, the table system 110b, and/or the user devices 102a-n) to operate in accordance with embodiments described herein.

The memory device 140 may store, for example, account, customer/player, and/or location data as well as various Application Programming Interface (API) modules, applications, etc., each of which may, when executed, participate in, facilitate, and/or cause gaming-related transactions to be conducted utilizing the passive NFC-enabled location devices 104a-n and active NFC-enabled user devices 102a-n, as described herein. In some embodiments, the memory device 140 may comprise any type, configuration, and/or quantity of data storage devices that are or become known or practicable. The memory device 140 may, for example, comprise an array of optical and/or solid-state hard drives configured to store digital image and/or video data, location data, NFC identification data, sensor data, business data, gaming model data (e.g., analysis formulas and/or mathematical models), credentialing instructions and/or keys, and/or various operating instructions, drivers, etc. In some embodiments, the memory device 140 may comprise a solid-state and/or non-volatile memory card (e.g., a Secure Digital (SD) card, such as an SD Standard-Capacity (SDSC), an SD High-Capacity (SDHC), and/or an SD extended-Capacity (SDXC) and any various practicable form factors, such as original, mini, and micro sizes, available from Western Digital Corporation of San Jose, CA. While the memory device 140 is depicted as a standalone component, the memory device 140 may comprise multiple components and/or instances. In some embodiments, a multi-component memory device 140 may be distributed across various devices and/or may comprise remotely dispersed components. Any or all of the user devices 102a-n, the gaming server 110a, the table system 110b, the network 108, and/or the location devices 104a-n may comprise the memory device 140 or a portion thereof, for example.

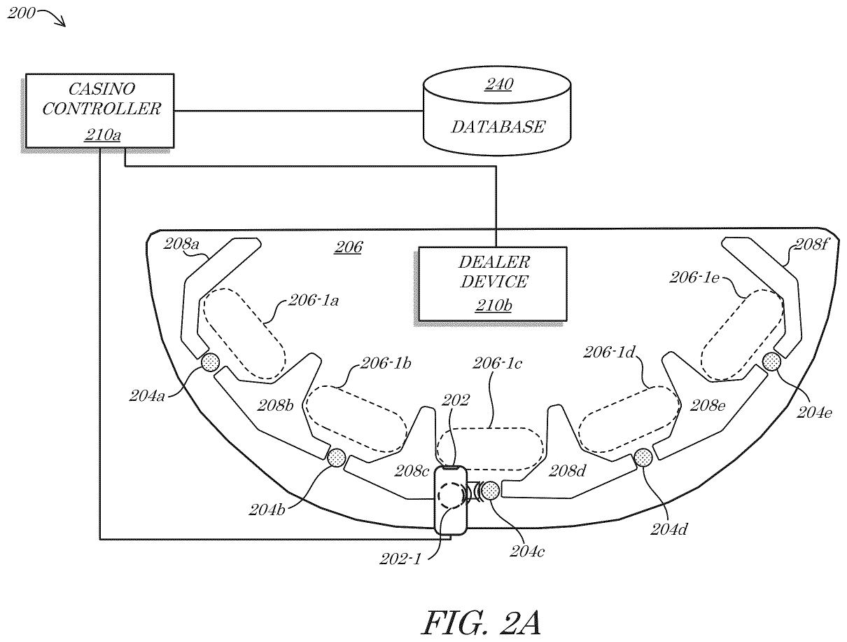

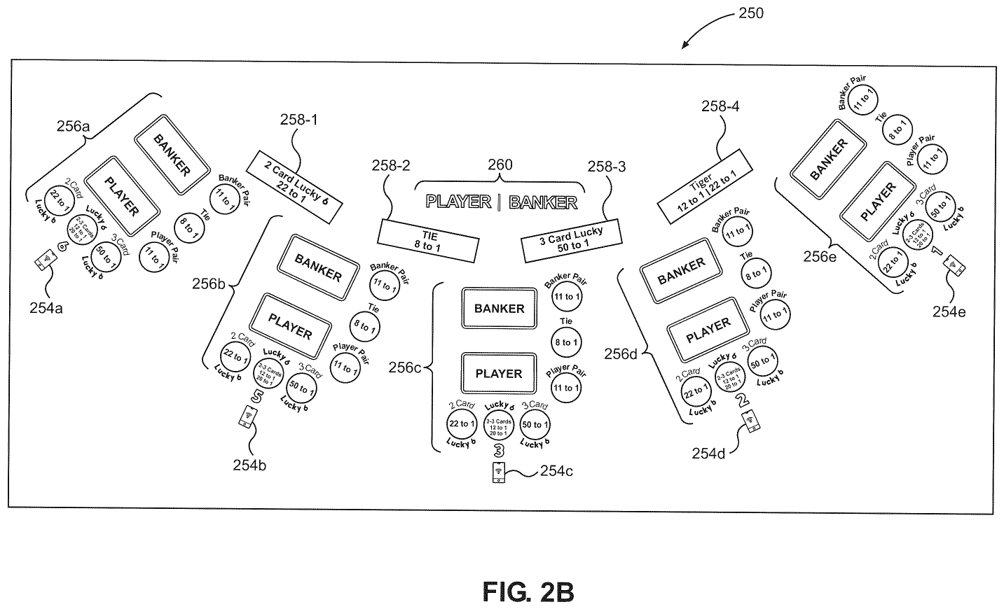

Turning to FIG. 2A, a block diagram of a system 200 according to some embodiments, is shown. In some embodiments, the system 200 may comprise a player device 202 (e.g., comprising an active NFC reader 202-1) and a plurality of passive NFC tags 204a-e coupled at various interspersed locations around a gaming table 206. According to some embodiments, each of the NFC tags 204a-e may be associated with a specific and/or particular location on (or at) the gaming table 206, such as a particular one of a plurality of bet and/or player positions, seats, and/or stations 206-1a, 206-1b, 206-1c, 206-1d, 206-1e. While the example embodiment of FIG. 2A shows the NFC 204a-e tags as being positioned in front of the respective player stations/positions 206-1a, 206-1b, 206-1c, 206-1d, 206-1e, between the respective shielding elements 208a-e, in other embodiments (such as that illustrated in FIG. 2 of Provisional Application No. 63/566,859, the NFC tags could be positioned in other locations that are nevertheless associated with a respective player station/position (such as within a respective player station/position 206-1a, 206-1b, 206-1c, 206-1d, 206-1e).

In some embodiments, the player device 202 (and/or the gaming table 206) may be in communication with a casino controller 210a and/or a dealer device 210b. As depicted for purposes of non-limiting example, the casino controller 210a may be in communication with the player device 202 and the dealer device 210b being disposed on (or at) the gaming table 206. In such a manner, for example, the casino controller 210a may manage communications with and/or between the player device 202 and the dealer device 210b to facilitate, execute, and/or manage an electronic table game (e.g., a wagering game) conducted at the gaming table 206. In some embodiments, the system 200 may comprise a database 240 that is in communication with and/or accessible to the casino controller 210a.

According to some embodiments, in practice (e.g., to initialize and/or conduct a passive NFC-enabled gaming transaction), a player/customer (not shown) may approach the gaming table 206 and place the player device 202 on (or in close proximity to) one of the player stations 206-1a, 206-1b, 206-1c, 206-1d, 206-1e. As depicted, the player device 202 may be placed on a third player station 206-1c. In some embodiments, the NFC tags 204a-e may be configured to be readable at a maximum range under approximately ten centimeters (10-cm), e.g., at a typical operational interrogation and/or activation range of between three and five centimeters (3 to 5-cm), and the player stations 206-1a, 206-1b, 206-1c, 206-1d, 206-1e may be spaced such that any single active NFC reader device such as the NFC reader 202-1 of the player device 202 may only be operable to read a single one of the NFC tags 204a-e from any single placement location at the gaming table 206. The player stations 206-1a, 206-1b, 206-1c, 206-1d, 206-1e may be situated more than ten centimeters (10-cm) apart, for example, to prevent the player device 202 (and/or the NFC reader 202-1 thereof) from reading more than one of the NFC tags 204a-e at a time (e.g., from a particular location at a particular time). In a case where the NFC tags 204a-e are configured for short-reading ranges such as three centimeters (3-cm) or less, the player stations 206-1a, 206-1b, 206-1c, 206-1d, 206-1e may be situated as close as five centimeters (5-cm) apart (or even less, depending upon the size of the player stations 206-1a, 206-1b, 206-1c, 206-1d, 206-1e).

In some embodiments, RFID shielding elements (e.g., aluminum sheets or plates cut into appropriate shapes to define desired shielded zones of the table 206) may be included in the system 200, so as to minimize or prevent unwanted readings or acquisitions of RFID-enabled wagering chips placed in so called “dead zones” created by these RFID shielding elements. For example, aluminum elements may be embedded within or attached to a layer of the table 206. Elements 208a-f illustrate non-limiting example placement of such shielding elements that can create zones within which RFID-enabled chips may be placed without being read or acquired by an RFID interrogator or antenna of the table 206.

In one example use case, upon placement of the player device 202 at or near the third player station 206-1c, the NFC reader 202-1 may activate, power, communicate with, and/or read a third NFC tag 204c disposed at, near (or within) the third player station 206-1c. According to some embodiments, the third NFC tag 204c may be installed underneath a player surface (not separately labeled, but an example of which is provided in FIG. 2B) of the gaming table 206 such as a typical felt playing surface layer and/or material, e.g., during (or subsequent to) construction/fabrication of the gaming table 206. In some embodiments, the NFC reader 202-1 of the player device 202 may read an identifier from the third NFC tag 204c, such as a Universally Unique Identifier (UUID) and/or Unique Tag IDentifier (UTID) stored therein (UUID being used to refer to either, for purposes of brevity). In some embodiments, an application executed on and/or by the player device 202 may read the UUID from the third NFC tag 204c and transmit the UUID along with player-specific data to the casino controller 210a. The player device 202 may, for example, transmit (either automatically or upon triggering by the player) the UUID and an identifier of the player (e.g., a player loyalty and/or account identifier) to the casino controller 210a.

According to some embodiments, the casino controller 210a (e.g., upon receipt of data from the player device 202 and/or the application executed thereon) may access the database 240 to identify, based on the UUID and/or the player data, one or more of: (i) the gaming table 206 (e.g., from a plurality of gaming tables 206, e.g., within a casino), (ii) the third player station 206-1c (e.g., a particular location at or on the gaming table 206), (iii) the player device 202 (e.g., from a plurality of player devices 202 at the same gaming table 206 and/or casino; e.g., in a case where the player data comprises a Medium Access Control (MAC) address, International Mobile Subscriber Identity (IMSI) number, Integrated Circuit Card IDentification (ICCID) number, phone number, etc. descriptive of the player device 202), (iv) the player, (v) a desired game that the player wishes to enter, (vi) a wager or buy-in amount, (vi) an offer that has been output to the player and/or accepted by the player, via a player device 202; and/or (vii) a product and/or service desired for purchase by the player (e.g., a drink, meal item, etc.). In some embodiments, the casino controller 210a may identify the gaming table 206 and the third player station 206-1c thereof and utilize the identify/location data to select and/or identify the dealer device 210b. The dealer device 210b may comprise, for example, a display device of the gaming table 206. According to some embodiments, the casino controller 210a may transmit, to the dealer device 210b, an indication that the player (e.g., as identified by their loyalty number, photo, image, avatar, etc.) has been seated or clocked-in at the third player station 206-1c. The casino controller 210a may also transmit wager information and/or other gaming settings, preferences, etc., as identified by the player data received from the player device 202. In such a manner, the dealer (not shown) at the gaming table 206 may be automatically notified when the player positions/seats themselves (e.g., via their player device 202) at the third player station 206-1c and/or may automatically clock-in the player, establish a starting wager amount (e.g., a “buy in”), game play position, etc.

In some embodiments, the dealer may be presented with identifying information descriptive of the player, such as a photo or image thereof, so that the dealer may confirm and/or verify that the correct player has been seated/clocked-in. In some embodiments, facial recognition may be used to confirm and/or verify the identity of the player (e.g., to confirm that the player image as obtained by a camera system utilizing facial recognition matches an image of a player corresponding to a player identifier at the relevant player seat or position). Commonly-owned U.S. Pat. No. 11,238,695 in the name of Moore et al. and titled SYSTEMS AND METHODS FOR VERIFYING PLAYER IDENTITY AT A TABLE GAME discloses various methods and systems for confirming and/or verifying an identity of a player at a table game by utilizing facial recognition technology. The passages of this patent that disclose the foregoing methods and systems are incorporated by reference herein for all purposes.

According to some embodiments, upon buy-in by the player, the dealer may provide the player with a commensurate value of “smart” wagering chips and/or tokens, such as RFID-enabled chips that may be tracked by active NFC and/or RFID components (not shown) of the gaming table 206 (e.g., RFID antennas or readers placed under each bet spot and other relevant areas of the gaming table). For example, each of the player positions 206-1a through 206-1e may include, in a layer of the table 206, two RFID antennas or interrogators, one under a “Player” bet spot and one under a “Banker” bet spot, so that the system 200 can recognize when a player sitting at a particular player position places a wager on “Player” or “Banker” for a given hand being dealt at the table 206. A non-limiting example of such a layout is described in U.S. Pat. No. 9,694,272 titled RFID SYSTEM FOR FACILITATING SELECTIONS AT A GAME APPARATUS, and particularly with reference to FIG. 4 thereof and the attendant description, which is incorporated by reference herein.

In a case where the gaming transaction initiated by the player comprises a request to purchase a product or service, the casino controller 210a may transmit the purchase request along with an identification of the gaming table 206 and/or the third player station 206-1c thereof to an appropriate transaction/purchase system (not shown), such as an in-casino POS system. In such a manner, the player may order a drink, food, and/or other product or service and have the product/service delivered/rendered directly to/at the third player station 206-1c, simply by scanning the third NFC tag 204c with the player device 202 and selecting a corresponding menu item via the application executed by the player device 202. In a case where the player move from one player station 206-1a, 206-1b, 206-1c, 206-1d, 206-1e to another or from one gaming table 206 to another, the application on the player device 202, in coordination with the casino controller 210a, may automatically update the player's location such that the ordered product/service can be delivered/rendered at the new location of the player. Payment for the product/service may, in some embodiments, be rendered and/or authenticated directly from the player data stored on and/or defined by the application executed on the player device 202.

While only a single one of the NFC tags 204a-e is depicted as corresponding to each of the player stations 206-1a, 206-1b, 206-1c, 206-1d, 206-1e, in some embodiments multiple NFC tags 204a-e may correspond to a given player station 206-1a, 206-1b, 206-1c, 206-1d, 206-1e, e.g., identifying different betting and/or other areas within each player station 206-1a, 206-1b, 206-1c, 206-1d, 206-1e. According to some embodiments, the NFC tags 204a-e may comprise and/or be paired with one or more piezoelectric effect and/or pressure sensors (not separately shown) to identify and/or facilitate identification of the player device 202 (e.g., to identify the act of placement thereof).

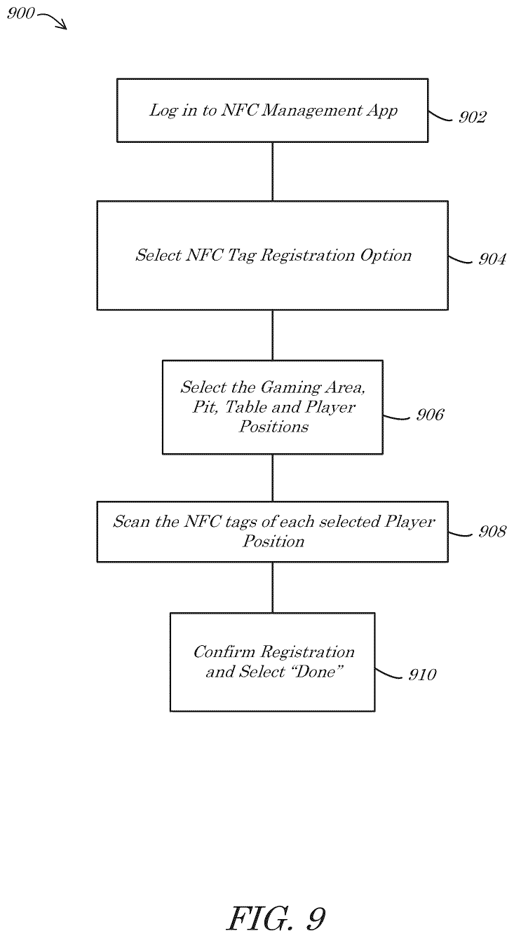

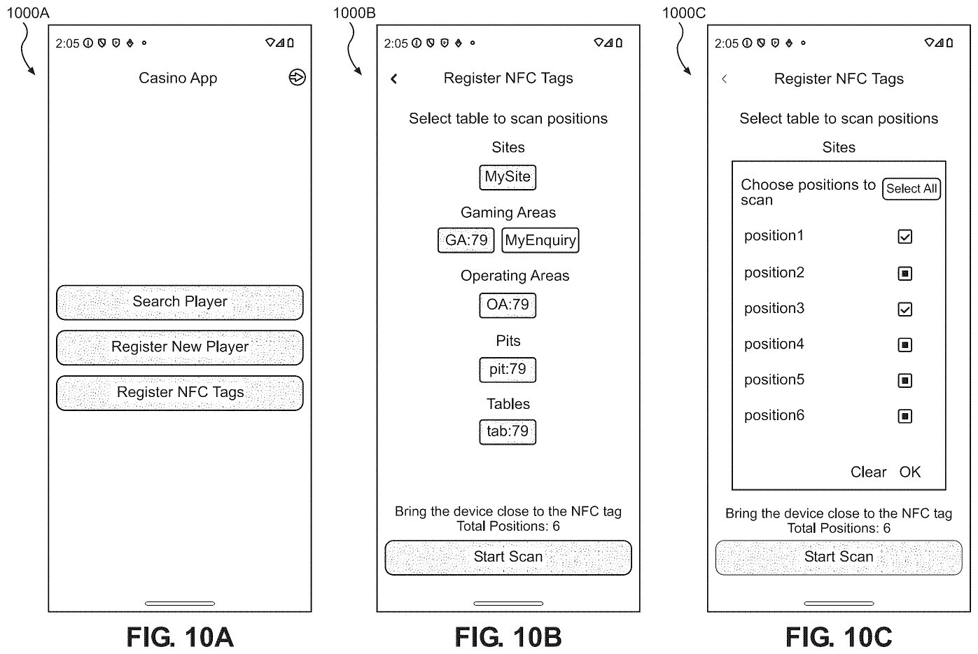

Fewer or more components 202, 202-1, 204a-e, 206, 206-1a, 206-1b, 206-1c, 206-1d, 206-1e, 210a-b, 240 and/or various configurations of the depicted components 202, 202-1, 204a-e, 206, 206-1a, 206-1b, 206-1c, 206-1d, 206-1e, 210a-b, 240 may be included in the system 200 without deviating from the scope of embodiments described herein. In some embodiments, the components 202, 202-1, 204a-e, 206, 206-1a, 206-1b, 206-1c, 206-1d, 206-1e, 210a-b, 240 may be similar in configuration and/or functionality to similarly named and/or numbered components as described herein. In some embodiments, the system 200 (and/or portions thereof) may comprise a passive NFC-enabled gaming system and/or a platform programmed and/or otherwise configured to execute, conduct, and/or facilitate the methods/algorithms 400, 700, 900 and 1000 of FIG. 4, FIG. 7, FIG. 9A and/or FIG. 10A herein, and/or portions or combinations thereof.

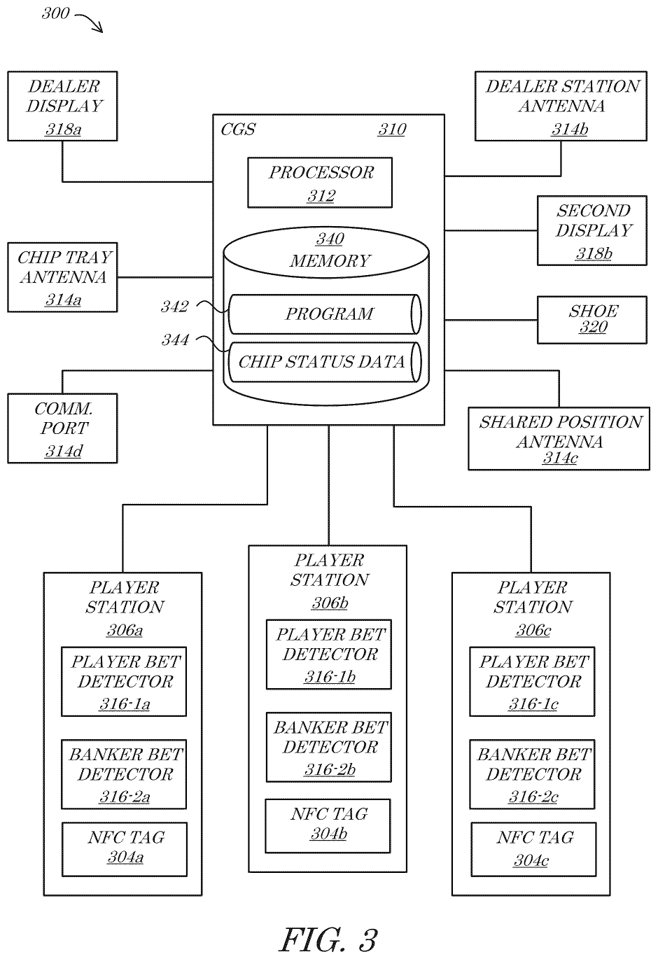

Referring now to FIG. 2B, illustrated therein is an example of a felt configuration 250 comprising a player-visible surface of a gaming table. In accordance with some embodiments, the felt configuration 250 may correspond to an NFC/RFID-enabled gaming table such as table 206 of FIG. 2A. The felt configuration 250 includes a plurality of player positions/stations 256a-e. Each player position/station 256a-e include several bet spots on which a player currently playing at that player position/station may place a wager by wagering chips thereon. In the example of FIG. 2B, each player position 256a-e includes a “PLAYER” bet spot and a “BANKER” bet spot, so that a player of a baccarat game can place a wager indication whether(s) he is betting that the PLAYER or BANKER will win the next hand being dealt. Each player position 256a-e also includes a plurality of different side or auxiliary wagers that the player can bet on (e.g., “Banker Pair”, “Tie”, “Player Pair”, “3-Card Lucky”, etc.). These side or auxiliary wagers are examples only, any type or number of side or auxiliary wagers (or none at all) may be included without departing from the spirit of the invention(s) described herein. The example felt layout 250 further includes areas 258-1 through 258-3 that each indicate the odds associated with the available side or auxiliary wagers, as well as a banker area 260. As described with reference to FIG. 2A and FIG. 3, each of the bet spots in each of the player positions 256a-e and/or the banker area 260 may include one or more RFID antennas or interrogators under the felt, such that the system may recognize that a player has placed a given bet by acquiring the one or more wagering chips placed thereon and reading the relevant information therefrom (e.g., chip value, number of chips, chip unique identifier, etc.).

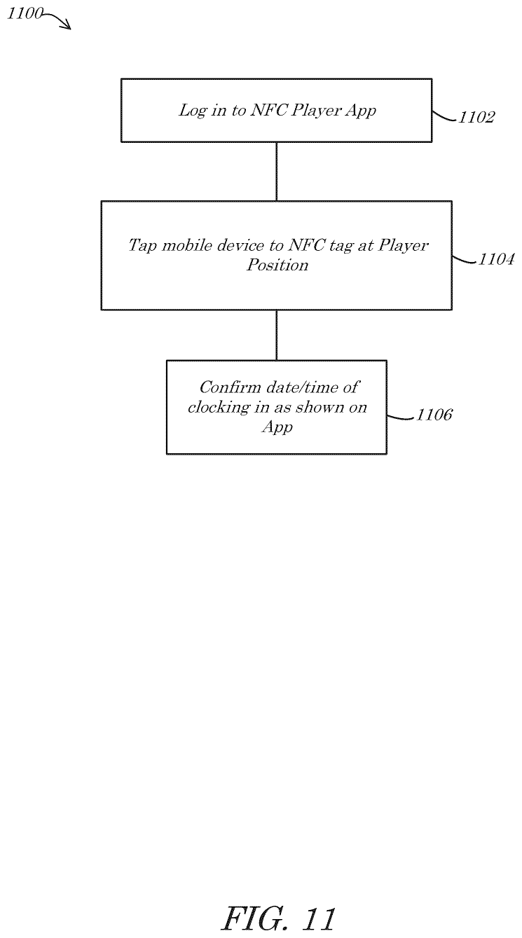

In accordance with one or more embodiments described herein, each player station/position 256a-e is has associated therewith an NFC area 254a-e (i.e., NFC area 254a corresponds to player position 256a, NFC area 254b corresponds to player position 256b, and so on). Under the felt, each NFC area 254a-e has placed thereon or attached thereto (in a layer of the table underneath the felt) a respective NFC chip. For example, the NFC areas 254a-e may correspond to the NFC tags 204a-e illustrated in FIG. 2A. In some embodiments, a wagering establishment may register each such NFC tag in its system so that players at a given player position 256a may take advantage of various functionality described herein (e.g., participate in transactions, accept offers, etc.) merely by touching their player device (e.g., a mobile phone that has an appropriate App installed therein), to the NFC area 254a-e corresponding to their player position. FIGS. 9 and 10A-10C illustrate a process and Graphical User Interfaces (GUIs) that may be utilized for an NFC tag registration process by casino personnel, while FIGS. 10 and 11A-11C illustrate a process and GUIs that may be utilized by a player to clock in and/or participate in one or more transactions using such a registered NFC tag.

Referring now to FIG. 3, a block diagram of a table system 300 according to some embodiments is shown. In some embodiments, the table system 300 may be implemented as a system controller, a dedicated hardware circuit, an appropriately programmed computer which is a component or peripheral device of a gaming table (not shown; e.g., the gaming table 106, 206 of FIG. 1 and/or FIG. 2 herein) for facilitating a table game, or any other equivalent electronic, mechanical or electro-mechanical device. According to some embodiments, the table system 300 may comprise a plurality of passive NFC tags 304a-c disposed at respective betting or player stations 306a-c. According to some embodiments, the player stations 306a-c may be substantively utilized to effectuate gaming sessions at the gaming table that may, for example, be executed as a “smart” or electronic gaming table via implementation of a Casino Gaming System (CGS) 310. In some embodiments, the CGS 310 may compromise at least one processor 312 (such as one or more INTEL® PENTIUM® processors) in communication with a plurality of communication devices 314 (such as a chip tray antenna 314a, a dealer station antenna 314b, a shared position antenna 314c, and/or a communication port 314d), a plurality of sensor devices 316 (such as player bet detectors 316-1a, 316-1b, 316-1c and/or banker bet detectors 316-2a, 316-2b, 316-2c), and/or output devices (such as a dealer display 318a and/or a second display 318b). In some embodiments, such as in the case that the table system 300 is configured for a card-style game, the table system 300 may comprise a card shoe 320. In some embodiments in which a player is able to place additional bets (e.g., one or more side or auxiliary bets, such as illustrated in the example felt layout of FIG. 2B), additional bet detectors may be included in each player station 306a-c or in other areas of the table system. For example, each available side bet (whether it is a bet available only for a particular player position or a shared bet position on which players from multiple player positions may place bets) may be associated with its own bet detector.

According to some embodiments, the processor 312 may be in communication with a memory 340 and the communication port 314d (e.g., for communicating with one or more other devices). The memory 340 may comprise an appropriate combination of magnetic, optical and/or semiconductor memory, and may include, for example, RAM, ROM, a compact disc, tape drive, and/or a hard disk. The memory 340 may comprise or include any type of computer-readable medium. The processor 312 and the memory 340 may each be, for example: (i) located entirely within a single computer or other device; or (ii) connected to each other by a remote communication medium, such as a serial port cable, telephone line or radio frequency transceiver. In some embodiments, the table system 300 may comprise one or more devices that are connected to a remote server computer (not shown) for maintaining databases.

The memory 340 may store a program 342 for controlling the processor 312. The processor 312 may perform instructions of the program 342, and thereby operate in accordance with at least one embodiment described herein. The program 342 may be stored in a compressed, uncompiled and/or encrypted format. The program 342 may include program elements that may be necessary or desirable, such as an operating system, a database management system and “device drivers” for allowing the processor 312 to interface with computer peripheral devices (e.g., detecting components such as the RFID antennas 314a-c, an RFID-enabled chip tray (not separately shown), the electronic shoe 320, a camera (also not shown), any of which may provide data to the processor 312). Appropriate program elements are known to those skilled in the art, and need not be described in detail herein. In accordance with some embodiments, program 342, a subroutine or module of program 342 or another program stored in memory 340 (or otherwise accessible to processor 312) may comprise instructions for applying at least some of the processes or functionalities described herein (e.g., executing an event at a gaming table utilizing the passive NFC tags 304a-c to effectuate a gaming transaction, a retail transaction or to provide a benefit to a player based on an offer the player has accepted).

Various forms of computer readable media may be involved in carrying one or more sequences of one or more instructions to processor 312 (or any other processor of a device described herein) for execution. For example, the instructions may initially be borne on a magnetic disk of a remote computer (not shown). The remote computer can load the instructions into its dynamic memory and send the instructions over a telephone line using a modem (also not shown). A modem local to the table system 300 may be operable to receive the data on the telephone line and use an infrared transmitter (not shown) to convert the data to an infrared signal. An infrared detector (also not shown) can receive the data carried in the infrared signal and place the data on a system bus (not separately depicted) for processor 312. The system bus may carry the data to a main memory, from which processor 312 may retrieve data and execute instructions. The instructions received by main memory may optionally be stored in memory 340 either before or after execution by processor 312. In addition, instructions may be received via communication port 314d as electrical, electromagnetic or optical signals representing various types of information. According to some embodiments, the instructions of the program 342 may be read into a main memory from another computer-readable medium, such from a ROM to RAM. Execution of sequences of the instructions in program 342 may cause processor 312 to perform at least some of the functions described herein. In alternate embodiments, hard-wired circuitry may be used in place of, or in combination with, software instructions for implementation of at least one embodiment described herein. Thus, embodiments described herein are not limited to any specific combination of hardware and software.

The memory 340 may also store data, such as chip status data 344. In some embodiments, data stored in the chip status data 344 may be partially or wholly stored (in addition to or in lieu of being stored in the memory 340 of the table system 300) in a memory of one or more other devices, such the gaming server 110a of FIG. 1 herein. In accordance with some embodiments, the chip status data 344 may store chip identification data and/or other chip status data (e.g., a status indication such as whether the chip is currently classified as an inventory chip or a non-inventory chip, denomination, unique chip identifier (e.g., UUID), chip set identifier, gaming establishment identifier, chip value, player identifier associated with chip identifier, bankroll identifier associated with a chip identifier, validity of chip, etc.). In some embodiments, the memory 340 may store additional data regarding movement, location or wagering activity which has occurred on the table. For example, chip movement history (e.g., an indication of which antennas or table bet positions a particular chip has been acquired at, a time at which it was acquired at a particular antenna, a time at which it was determined to no longer be at that antenna, etc.) may be stored. In some embodiments, a history of chip movements may be stored (e.g., in a file-based archive log) on another device (e.g., in the database 140 of FIG. 1 herein).

In some embodiments, chip status data 344 or another table or memory device may be used to dynamically track stacks of chips or wagers for a game event. For example, the database or table may be updated as data is received from the dealer antenna (e.g., based on inventory chips being placed onto and then removed from a dealer antenna) and the CGS 310 may determine whether to change the status of the chips from inventory to non-inventory based on rules for determining such status. The CGS 310 may be programmed (e.g., via program 342) to recognize that if one or more inventory wagering chips the value of which is equal to an amount to be paid out to a player for a winning wager are placed onto and then removed from the dealer antenna the status of each of those chips should be changed to non-inventory since they are presumed to be now paid out to the appropriate player as a result of the winning wager.

The processor 312 may also be operable to communicate with one or more display devices: (i) the dealer display 318a and/or the second display 318b. The second display 318b may comprise, for example, a display for displaying historical outcomes or other game information to a player (e.g., a trend board). The dealer display 318a may output information such as (i) prompts for how much should be collected from players in commission or losing wagers (e.g., for each player position involved in the hand); (ii) prompts for how much should be paid out to players for winning wagers (e.g., for each player position involved in the hand); (iii) prompts asking the dealer to confirm that a specific type of transaction is in progress and/or a message to the dealer that the value of the inventory chips comprising the transaction; (iv) tray variance or out-of-balance alerts, informing the dealer of missing chips from the RFID-enabled chip tray; (v) identity and/or game play information for a player that has just seated themselves at a gaming table for the game (e.g., based on management of passive NFC data related to the player, player's device, and/or specific locations associated with the game/gaming table); (v) instruction to provide wagering chips or other benefit to a player at a particular player position based on an offer the player has accepted by tapping his player device to an NFC tag at his/her player position; and/or (v) other information regarding a status of the game, including information regarding a status of one or more wagers or RFID-enabled chips being used on the table. In some embodiments, one or both of the displays 318a-b may include or have associated therewith its own processor, memory and program (and may be operable to communicated data to and/or from the processor 312). Either of the display devices 318a-b may comprise, for example, one or more display screens or areas for outputting information related to game play on the gaming system, such as a Cathode Ray Tube (CRT) monitor, Liquid Crystal Display (LCD) screen, or Light-Emitting Diode (LED) screen. In some embodiments, either of the display devices 318a-b may comprise a touch screen.

In some embodiments an RFID-enabled chip tray may comprise one or more antennas for reading information from RFID-enabled chips placed in the chip tray. In such embodiments, the processor 312 is further operable to communicate with the one or more chip tray antenna(s) 314a. The one or more antenna(s) 314a may be operable to read data from one or more chips placed within a chip tray (e.g., chip identifier, chip set identifier, chip denomination, etc.). In accordance with some embodiments, the CGS 310 may be programmed to recognize a chip that is detected as having been placed on a wager placement position as a payout chip if that chip was recognized by the CGS 310 as being in the chip tray (e.g., based on data received from the chip tray antenna(s) 314a immediately prior to being detected on the wager placement position). According to some embodiments, the processor 312 may also or alternatively be operable to communicate with the shared position antenna 314c, which comprises at least one antenna on a shared or common betting area for recognizing chips placed (and removed from) the shared or common betting area.

In some embodiments, the processor 312 may also or alternatively be operable to communicate with a plurality of detecting components (e.g., RFID antennas or optical imaging components) at physical player stations 306a-c (also referred to as physical player positions) of the physical table. According to some embodiments, each physical player position 306a-c of a physical gaming table may have a corresponding “Player bet spot area” and a “Banker bet spot area” and each such area may have associated therewith its own antenna or other detecting component for determining that a wagering chip or other gaming element has been placed within this area and thus that a wager has been placed on either a “Player win outcome” or a “Banker win outcome”. For purposes of non-limiting example, the table system 300 illustrates three player positions or stations 306a-c as each having two detecting components associated therewith: a Player Bet detector 316-1a, 316-1b, 316-1c and a Banker Bet detector 316-2a, 316-2b, 316-2c. Thus, a first player station 306a may have associated therewith a first Player Bet detector 316-1a and a first Banker Bet detector 316-2a, a second player station 306b may have associated therewith a second Player Bet detector 316-1b and a second Banker Bet detector 316-2b, and a third player station 306c may have associated therewith a third Player Bet detector 316-1c and third Banker Bet detector 316-2c.

Each detecting component 316-1a, 316-1b, 316-1c, 316-2a, 316-2b, 316-2c may be uniquely identifiable by, for example, (i) a unique identifier associated therewith, and (ii) an identification of a port or other component of the table associated with the antenna (e.g., the port into which the antenna is plugged into may have a unique identifier associated therewith) and such unique identifier may be transmitted to or recognized by the processor 312 when chip information regarding a chip acquired by a respective detecting component is transmitted to the processor 312, such that the processor 312 may be programmed to determine which player position 306a-c and which wager placement position within the player position the wagering chip has been placed on. In some embodiments, the chip status data 344 may store detailed data with information regarding chips identified at a table, such details being associated with a chip identifier of each chip for which data is stored (e.g., chip value, chip denomination, chip set identifier, bankroll identifier or other indicator of a category or characteristic associated with a chip, time of acquisition, which stack or wager the chip is associated with, etc.). Storing such data at the table may allow for faster RFID scanning or other detecting, since the system will not need to obtain a lot of data every time a chip is acquired or recognized by an antenna or other detecting component of a table (e.g., only the chip identifier may be necessary and additional information, such as whether the chip is an inventory chip or a non-inventory chip, may be looked up by the system based on the chip identifier from a local database or memory). As described, in some embodiments additional bets may be available on the table 300 and these may correspond to additional detecting components on the table, for detecting that one or more wagering chips has been placed thereon to define a wager made.

In some embodiments, the CGS 310 may be operable to communicate with the electronic shoe 320. The shoe 320 may be an intelligent shoe such as the IS-T1™ and IS-B1™ or the MD1, MD2 sold by SHUFFLE MASTER or other such devices. The shoe 320 may be able to determine which cards are being dealt to which player station, through RFID technology, image recognition, a printed code on the card (such as a barcode), or the like. The embodiments described herein are not dependent on any particular technique used to recognize cards dealt in a card game (or cards remaining as available to be dealt). Further information about intelligent shoes may be found in U.S. Pat. Nos. 5,941,769 and 7,029,009, the intelligent shoe concepts and descriptions of which are hereby incorporated by reference herein. In place of an intelligent shoe, cameras, such as may be used with pattern recognition software to detect what cards have been dealt to what player stations and what chips have been wagered at particular player stations. One method for reading data from playing cards at table games is taught by German Patent Application No. P44 39 502.7. Other methods are taught by U.S. Patent Application Publication 2007/0052167 the optical card reading concepts and descriptions of both of which are hereby incorporated by reference herein.

According to some embodiments, the CGS 310 may be operable to communicate with the dealer station antenna 314b, which comprises one or more antennas placed in a dealer area of the corresponding table. The dealer station antenna 314b may be operable to detect RFID-enabled chips which have been placed within its acquisition area, such as chips the dealer places in the area for recognizing by the system prior to placing them into the dealer tray or paying them to a player. In some embodiments, the CGS 310 may be operable to determine whether the chips detected by the dealer station antenna 314b include both inventory and non-inventory chips at any given time.

In some embodiments, the NFC tags 304a-c may comprise, store, and/or be assigned a particular identifier such as a UUID. The identifier may, as described herein, be acquired by an NFC reader (not shown; e.g., the NFC reader 202-1 of FIG. 2 herein) in a case where the NFC reader is placed in close proximity to a particular one of the NFC tags 304a-c. According to some embodiments, each player station 306a-c may be physically separated (and/or separated by shielding elements underneath the felt of the table, such as described with reference to FIG. 2A) such that only a single one of the NFC tags 304a-c may be read by an NFC reader (such as is typical in smart phones) positioned at any given physical location of the gaming table associated with the table system 300. In such a manner, for example, an NFC reader placed at, near or in a second player station 306b may read (or may only read) a second passive NFC tag 304b upon placement, “tapping”, etc. In some embodiments, the NFC reader may pass the UUID of the second NFC tag 304b to a processing device or server (not shown; e.g., the gaming server/casino controller 110a, 210a of FIG. 1 and/or FIG. 2A herein) where a relation of the UUID of the second NFC tag 304b is stored with respect to the second player station 306b (and/or a portion thereof). According to some embodiments, the CGS 310 may receive an indication that a particular player has become (e.g., by scanning the second NFC tag 304b) associated with/assigned to the second player station 306b. In some embodiments, the CGS 310 may pass player information such as a player loyalty number and/or photo to the dealer display 318a, e.g., to alert the dealer of the seating/clocking-in of the player at the second player station 306b. In some embodiments, data relating the NFC tags 304a-c to the player stations 306a-c may also or alternatively be stored in the memory 340 and/or the NFC reader may interface directly with the table system 300, e.g., to conduct passive NFC-enabled gaming transactions at the gaming table associated with the table system 300.

Fewer or more components 304a-c, 306a-c, 310, 312, 314a-d, 316-1a, 316-1b, 316-1c, 316-2a, 316-2b, 316-2c, 318a-b, 320, 340, 342, 344 and/or various configurations of the depicted components 304a-c, 306a-c, 310, 312, 314a-d, 316-1a, 316-1b, 316-1c, 316-2a, 316-2b, 316-2c, 318a-b, 320, 340, 342, 344 may be included in the table system 300 without deviating from the scope of embodiments described herein. For example, in some embodiments each player station 306a-c may include its own player display via which game-related and/or player-related information may be output to the player of that position. For example, one or more offers may be output to the player (e.g., increase your average bet and get $10 in promotional wagering chips or digital currency, agree to eat at a particular restaurant today and get $25 in promotional wagering chips or digital currency, agree to sign up for a player reward account and get a 2X multiplier on your next bet, etc.).

In some embodiments, the components 304a-c, 306a-c, 310, 312, 314a-d, 316-1a, 316-1b, 316-1c, 316-2a, 316-2b, 316-2c, 318a-b, 320, 340, 342, 344 may be similar in configuration and/or functionality to similarly named and/or numbered components as described herein. In some embodiments, the system 300 (and/or portions thereof) may comprise a passive NFC-enabled gaming system and/or a platform programmed and/or otherwise configured to execute, conduct, and/or facilitate the methods/algorithms 400, 700, 900 and 1100 of FIG. 4, FIG. 7, FIG. 9 and/or FIG. 11 herein, and/or portions or combinations thereof.

Although the example table game (and attendant layout or configuration of bet spots and NFC tag positions) illustrated in FIGS. 2A, 2B and 3 is for a game of baccarat, the embodiments described herein are not limited to baccarat games. For example, the functionality vis-à-vis NFC tags (e.g., allowing a player to initiate a transaction or accept an offer presented via a mobile device or player screen of the table by tapping a mobile or other user device that includes an NFC reader 202 to an NFC tag placed on the table) may be incorporated into other types of table games. For example, NFC tags and corresponding functionality may be applied on a poker game table, a blackjack table or a roulette table. Similarly, the RFID technology described with respect to FIGS. 2A, 2B and 3 for purposes of recognizing and managing wagering chips and events on a table game is not necessary for all embodiments. For example, optical recognition technology could be deployed (in lieu of or in addition to RFID technology) for purposes of supporting wagering activity (e.g., to recognize or manage placement of wagering chips on bet spots of the table, confirmation of payouts made or losing bets collected, etc.), and the NFC tag technology described herein for activities such as enabling transaction or acceptance of offers may be utilized alongside the optical recognition technology.

### III. Passive NFC-Enabled Gaming Table Methods

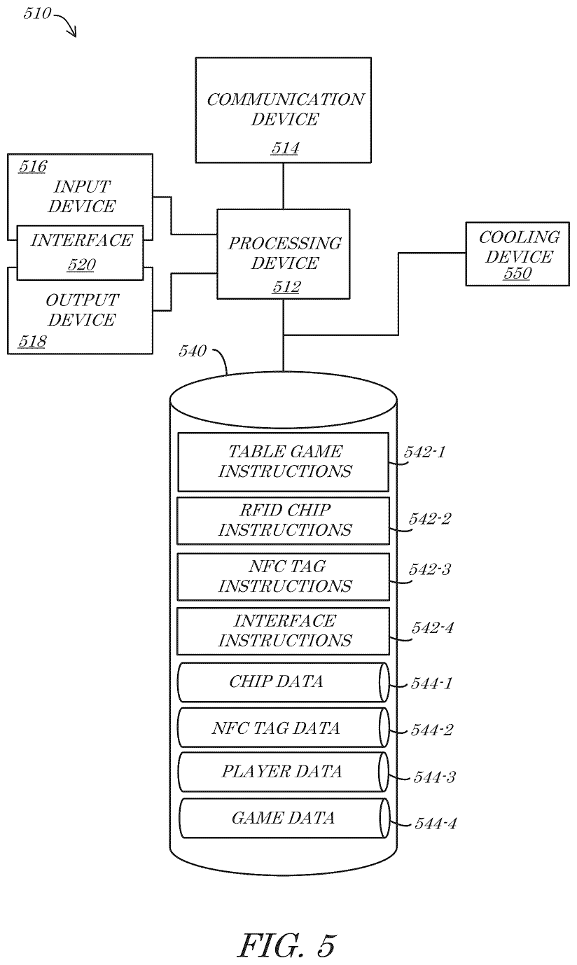

Referring now to FIG. 4, a flow diagram of a method 400 according to some embodiments is shown. In some embodiments, the method 400 may be performed and/or implemented by and/or otherwise associated with one or more specialized and/or specially-programmed computers (e.g., one or more of the user devices 102a-n, 202, the gaming server/casino controller 110a, 210a, the table systems/dealer device 110b, 210b, 300 and/or the apparatus 510 of FIG. 1, FIG. 2, FIG. 3, and/or FIG. 5 herein), computer terminals, computer servers, computer systems and/or networks, and/or any combinations thereof (e.g., by one or more multi-threaded and/or multi-core processing units of a passive NFC-enabled gaming system). In some embodiments, the method 400 may be embodied in, facilitated by, and/or otherwise associated with various input mechanisms and/or interfaces (such as the interface 520 of FIG. 5 herein).

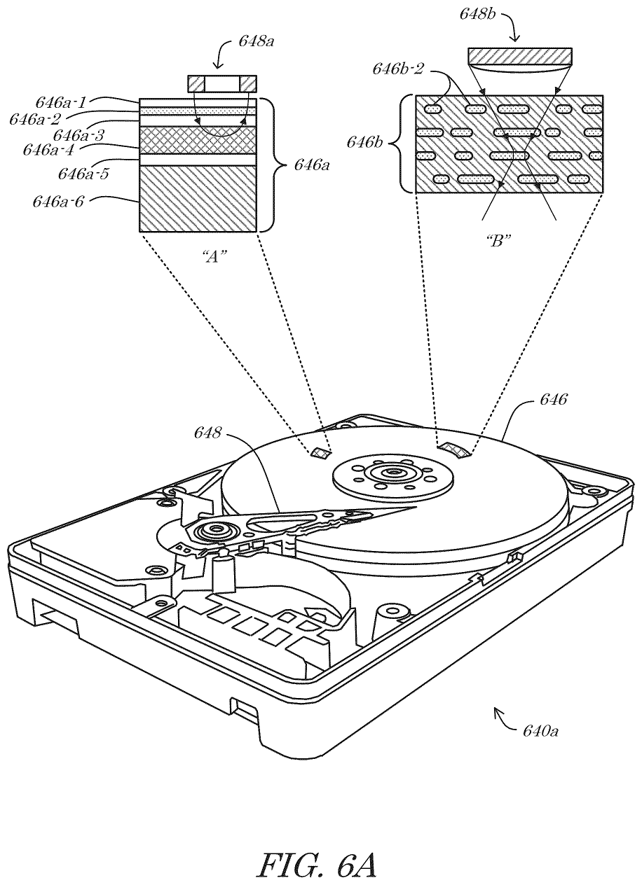

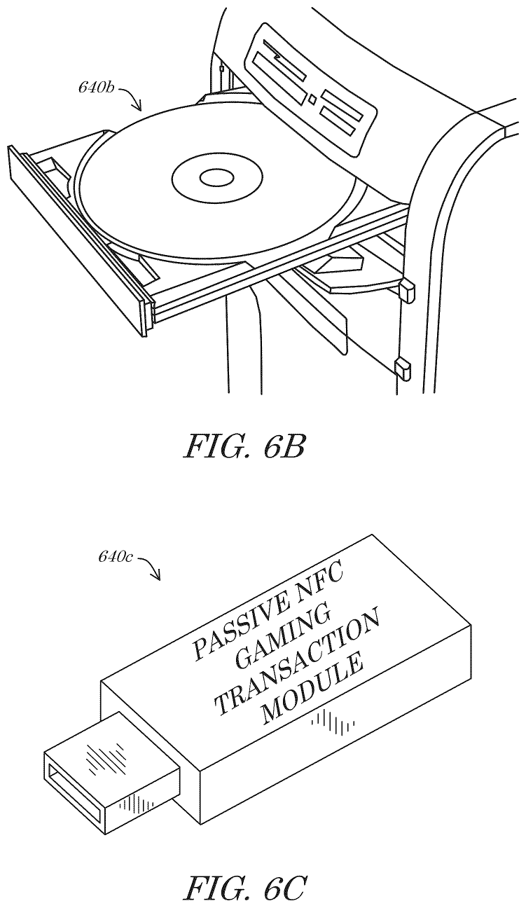

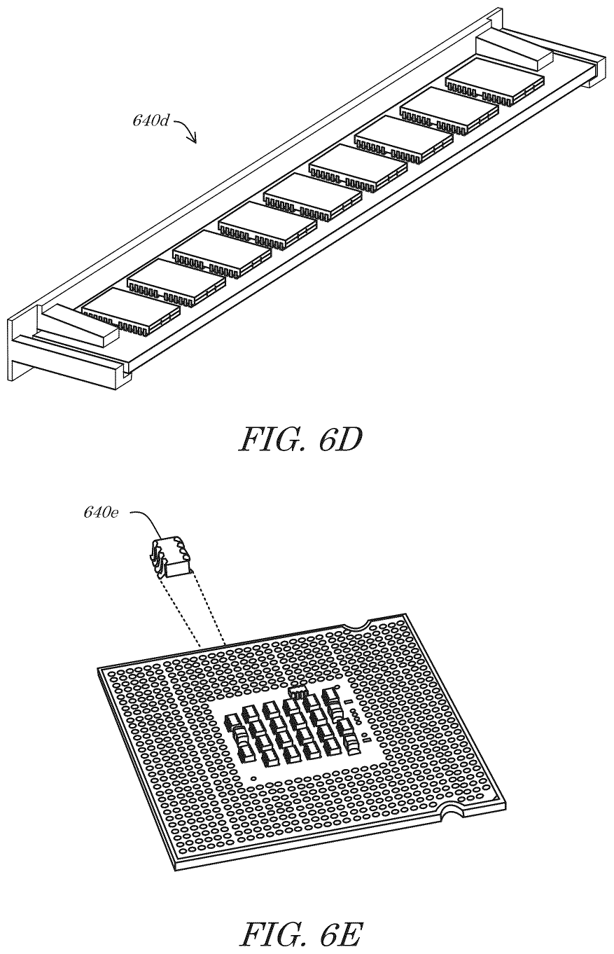

The process diagrams and flow diagrams described herein do not necessarily imply a fixed order to any depicted actions, steps, and/or procedures, and embodiments may generally be performed in any order that is practicable unless otherwise and specifically noted. Different depicted actions, steps, and/or procedures may be performed, unless specifically noted otherwise, in parallel or in series. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140, 240, 340, 540, 640a-e of FIG. 1, FIG. 2, FIG. 3, FIG. 5, FIG. 6A, FIG. 6B, FIG. 6C, FIG. 6D, and/or FIG. 6E herein) may store thereon instructions that when executed by a machine (such as a computerized processor and/or electronic processing device) result in performance according to any one or more of the embodiments described herein.

In some embodiments, the method 400 may comprise affixing passive NFC tags to a gaming table, at 402. This may be done during the manufacturing process of the gaming table. Once a gaming table is placed in a wagering establishment, in some embodiments the NFC tags included therein may be registered with the wagering establishment system. An example of a process that a user (e.g., personnel of a wagering establishment in which such a gaming table is placed) may follow to register such NFC tags is illustrated in FIG. 9, with FIGS. 10A-C illustrating example GUIs that the user may utilize during such a process.

One or more passive tags such as passive NFC tags may, for example, be coupled to and/or embedded in a gaming table such as underneath a playing surface thereof. According to some embodiments, such as in a case where the gaming table is constructed of multiple layers of material, the one or more NFC tags (e.g., such as embodied in NFC tag package 80 of FIG. 8) may be disposed between layers, e.g., during construction and/or retrofitting of the gaming table. In other embodiments, NFC tags may be positioned on a gaming table post-manufacturing, whether on the surface or underneath a felt or other top layer of the gaming table. In some embodiments, such as in a case that the gaming table comprises a finished playing surface such as a felt or felt-like surface typical for many gaming tables, the NFC tags may be embedded underneath the felt surface, e.g., sandwiched between the felt or upper surface and a lower or substrate surface. An example of such a table game layer illustrating example positioning of NFC tags thereon is illustrated in FIG. 2A, and an example of a felt layout layer consistent with embodiments described herein is illustrated in FIG. 2B. According to some embodiments, the NFC tags may be adhered to and/or etched into the upper or top (e.g., felt) playing surface of the gaming table or a visual representation of such NFC tags that are placed in a layer under the felt or top layer may be included on the felt or top layer (e.g., as illustrated in FIG. 2B). In some embodiments, a passive NFC tag may be coupled and/or placed to correspond with each of a plurality of player positions or stations, betting/wager areas or spots, and/or other designated areas on the gaming table surface. In some embodiments, a plurality of gaming tables that each comprise a plurality of passive NFC tags may be placed, e.g., in a particular wagering establishment such as a casino.

According to some embodiments, the method 400 may comprise storing (e.g., by an electronic processing device) data relating the NFC tags to particular locations at the gaming table, at 404. In other embodiments, a registration process for NFC tags may be performed by personnel of a wagering establishment at which the gaming table is placed (as described with reference to FIG. 9 and FIGS. 10A-10C). Each NFC tag may comprise an identifier such as a UUID and each particular location at the gaming table (e.g., on a playing surface thereof) may be uniquely identifiable, for example. Upon and/or at the time of placement, embedding, etching, adhering, and/or coupling of the NFC tags to the gaming table locations, each location identifier may be recorded with respect to each NFC tag positioned at the particular location (or, as described with respect to FIG. 9 and FIGS. 10A-10C, this association of NFC tags may be performed post-manufacturing, by personnel of a wagering establishment). According to some embodiments, an installer may utilize a scanning device (e.g., an active NFC reader/encoder, which may be embodied as a software App and hardware of a user's mobile device) to read (and/or write) an identifier for each NFC tag in and store the identifier in relation to the location at which the NFC tag is placed. In some embodiments, a device utilized by the installer may be pre-programmed with the available locations (e.g., player stations, bet spots) at the gaming table and provide an interface where the installer may choose a particular location (e.g., from a listing) and scan the corresponding NFC tag to automatically store the identifier of the NFC tag in association with the selected location. The relational data may, in some embodiments, be transmitted to and/or stored in a database, e.g., of a casino gaming system/controller.

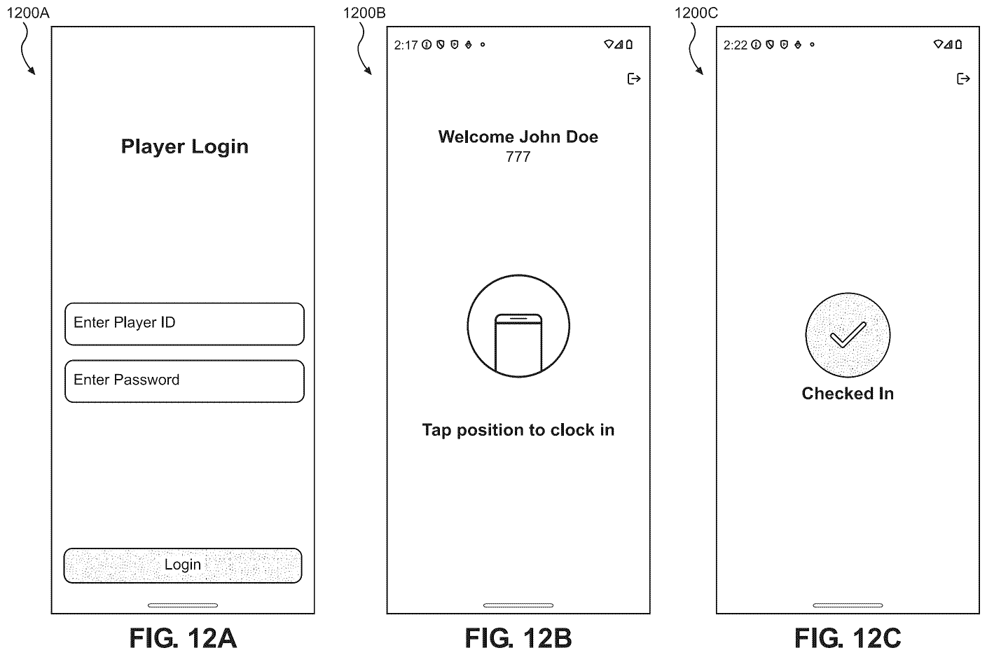

In some embodiments, the method 400 may comprise receiving (e.g., by the electronic processing device and/or via an electronic and/or wireless network) NFC tag and player data, at 406. According to some embodiments, the receiving may occur subsequent to the affixing and storing. While the affixing and storing may comprise portions of a construction and/or gaming table placement process, for example, once the gaming table (or plurality of gaming tables, in the case of a multi-table establishment such as a casino) is placed and made available for gaming activities, a player desiring to play a game at the gaming table may approach the table and scan one of the passive NFC tags of the table with their own mobile device/active NFC reader. An example of a process in which a player “clocks in” at a gaming table using a software App on their mobile device is described with reference to FIG. 11 and FIGS. 12A-C. In some embodiments, an application executed on the player's mobile device may store information identifying the player such as the player's loyalty number, an account number, name, address, etc. According to some embodiments, upon detection and/or interrogation of the particular NFC tag at the particular location at the gaming table upon which the player's device is placed, the application may automatically read the identifier of the NFC tag and transmit an indication of the NFC tag identifier along with data descriptive of the player (e.g., an identifier of the player) to a computer system such as a casino gaming system/controller. In some embodiments, the application may transmit the data (NFC tag and player data) directly to a receiver of the gaming table. Accordingly, the casino controller and/or the electronic gaming table itself may receive the NFC tag and player information from the player's device. In the case of the casino controller being the recipient, the information may be transmitted over a cellular telephone network and/or over a wireless network, e.g., inside and/or provided by the casino. In the case that the electronic gaming table is the recipient, the information may be similarly received via cellular and/or Wi-Fi® networks, and/or may be received via a short- range wireless communication network and/or protocol such as Bluetooth®, IR (and/or other optical), and/or short-range RF transmissions.

According to some embodiments, the method 400 may comprise storing (e.g., by the electronic processing device) data relating the player to a particular location at the gaming table, at 408. In response to the receiving of the NFC tag and player data, for example, the receiving device/system may create and/or update a database record to indicate that the player (identified by the player data) is now associated with (e.g., “seated” and/or “clocked-in” at) the particular location of the gaming table that corresponds to the received NFC tag data. The NFC tag data received form the player device may, for example, be utilized to query a database storing the relational data (e.g., stored at 404) matching NFC tags to gaming table locations, and the particular location stored in association with the identified NFC data from the player may be identified. The identified location may then be assigned to the player, e.g., by creating or updating a database record in reference to the particular location (e.g., at the particular gaming table). In some embodiments, the stored data may be strategically separated, e.g., by storing different portions of the data in different database and/or memory devices. The gaming table may store data defining the particular locations at the gaming table and may maintain data tracking players associated with those locations, for example, while the casino system may store the data relating the NFC tag data to the particular locations. According to some embodiments, even if multiple data stores are employed, they may store replications of the same data. The casino system and the gaming table may store the NFC tag data, gaming table location data, and player data in a blockchain, for example, where each separate data store may be utilized to verify/authenticate the other.

In some embodiments, the method 400 may comprise executing (e.g., by the electronic processing device) a gaming transaction for the player at the particular location at the gaming table, at 410. In the case that the casino system receives the data from the player device, for example, the casino system may transmit data to the gaming table to cause the gaming table (and/or a dealer/manager thereof) to assign the player to the particular player station/location, e.g., to be clocked-in for the next gaming session, round, hand, spin, etc. (e.g., one type of gaming transaction—namely, seating/clocking-in a player; e.g., “activating” the gaming table). According to some embodiments, the casino system may transmit not only an account number or numeric identifier of the player (e.g., a player loyalty number) but also a visual indication of the player such as a photo and/or biometric data tag or reference. The gaming table system and/or dealer/manager thereof may, for example, utilize the visual indication and/or biometric data to verify that the player currently present at the particular location at the gaming table matches the description received from the casino system (e.g., another type of gaming transaction—namely, player verification). In some embodiments, the particular location may be pre-associated with and/or the player data may be descriptive of data defining specific parameters for a gaming transaction. The particular location of the player device may correspond to a spot for a particular type and/or amount of wager, for example, and the association of the player with the particular location may automatically define (e.g., by the casino system and/or gaming table querying stored data) a particular wager, wager type, wager amount, etc. (e.g., another type of gaming transaction—namely, placing a particular wager/wager amount). In some embodiments, the player data may define the wager, wager amount, and/or other gaming parameters. The player may utilize an interface provided by the application on their mobile device, for example, to define the gaming parameters and send them to the casino system/gaming table along with (or subsequent to) the NFC tag data.

According to some embodiments, a gaming transaction may be defined by the application executed on the player's device. Once associated with (e.g., seated at and/or clock-into) the particular location, for example, the player may utilize the application to (i) indicate one or more purchase transactions desired by the player; and/or (ii) one or more offers being accepted by the player. An acceptance of an offer (and the provision to the player of a benefit defined by the offer) may therefore be a gaming transaction as contemplated herein.

For example, the player may define an order for a beverage or food product, for example, or may order a service. In another example, an offer may be output to the player (e.g., via a player display of the gaming table or via the player's mobile device on which the application is running), offering the player a defined benefit in exchange for an agreed-upon action or commitment. Examples of benefits that may be defined by such an offer include, without limitation: (i) promotional currency (whether physical or virtual) to be used for wagering or purchases; (ii) coupons, discounts, rebates or vouchers for free or discounted products or services (e.g., available from the wagering establishment or associated third party retailers); (iv) free games or bonus games (e.g., at the gaming table the player is currently playing at, or at another gaming device such as another gaming table or a slot machine); (v) access to in-game features such as multipliers, side-wagers, increased odds, favorable payout schedules, ability to re-play part or all of a game, etc.; or (vi) access to information not typically available to the player, such as information on past trends, non-private information about other players at the table or helpful hints for playing a wagering game. Examples of agreed-upon actions or commitments that may be defined by an offer output to a player include, without limitation: (i) agreement to increase a wager amount, average wager; (ii) agreement to increase a rate of play or duration of play; (iii) agreement to purchase or sample a specified product or service; (iv) agreement to play or participate in a specific game or gaming experience (e.g., at a particular date, time or location); (v) agreement to promote or invite other persons to try a particular gaming establishment, game, retailer or service; and/or (vi) commitment to utilize a certain strategy, game mechanic, feature or wager type (e.g., max bet) for a particular game. Thus, for example, a wagering establishment or associated retailer may utilize the information gathered via embodiments described herein (e.g., that a particular player has clocked-in at a particular player position of a table game) to output one or more offers to the player (e.g., via a display of the gaming table or the player's mobile device used to clock-in). The player may indicate an acceptance of one or more such offers by tapping his mobile device to the NFC tag at his player position. The player's acceptance may cause the system to provide the player with the benefit defined by the accepted offer. For example, a specified amount of virtual promotional currency may be added to an account of the player or the dealer may be instructed to provide to the player (based on the player position corresponding to the NFC chip used to accept the offer) to provide the appropriate value of physical promotional currency to the player.

In some embodiments, data defining a purchase transaction may be provided with the NFC data as part of the player data and/or may be transmitted subsequent to the assignment of the player to the particular location. According to some embodiments, the casino system (or gaming table) may process the requested purchase transaction. The casino system may, for example, transmit an order for the desired product/service to a POS (an ordering system, waitstaff device, etc.) within the casino. In some embodiments, purchase transaction data transmitted to the POS may include an identification of the particular location (e.g., within the casino and/or at the particular gaming table). In some embodiments, such as in the case that the player data comprise payment data, the purchase transaction data may include the payment data to verify and/or resolve payment for the transaction. According to some embodiments, the ordered product and/or service may delivered to and/or rendered at the particular location at the gaming table (e.g., another type of gaming transaction—namely, a product/service delivered to a particular player station at a particular gaming table).

### IV. Passive NFC-Enabled Gaming Table Apparatus & Articles of Manufacture

Turning to FIG. 5, a block diagram of an apparatus 510 according to some embodiments is shown. In some embodiments, the apparatus 510 may be similar in configuration and/or functionality to one or more of the user devices 102a-n, 202, the gaming server/casino controller 110a, 210a, the table systems/dealer device 110b, 210b, 300, herein. The apparatus 510 may, for example, execute, process, facilitate, receive the benefit of and/or otherwise be associated with the methods/algorithms 400, 700, 900, and/or 1100 of FIG. 4, FIG. 7, FIG. 9 and/or FIG. 11 herein, and/or portions or combinations thereof. In some embodiments, the apparatus 510 may comprise a processing device 512, a communication device 514, an input device 516, an output device 518, an interface 520, a memory device 540 (storing various programs and/or instructions 542 and data 544), and/or a cooling device 550. According to some embodiments, any or all of the components 512, 514, 516, 518, 520, 540, 542, 544, 550 of the apparatus 510 may be similar in configuration and/or functionality to any similarly named and/or numbered components described herein. Fewer or more components 512, 514, 516, 518, 520, 540, 542, 544, 550 and/or various configurations of the components 512, 514, 516, 518, 520, 540, 542, 544, 550 may be included in the apparatus 510 without deviating from the scope of embodiments described herein.

According to some embodiments, the processor 512 may be or include any type, quantity, and/or configuration of processor that is or becomes known. The processor 512 may comprise, for example, an Intel® IXP 2800 network processor or an Intel® XEON™ Processor coupled with an Intel® E7501 chipset. In some embodiments, the processor 512 may comprise multiple interconnected processors, microprocessors, and/or micro-engines. According to some embodiments, the processor 512 (and/or the apparatus 510 and/or other components thereof) may be supplied power via a power supply (not shown), such as a battery, an Alternating Current (AC) source, a Direct Current (DC) source, an AC/DC adapter, solar cells, and/or generator. In the case that the apparatus 510 comprises a server, such as a blade server, necessary power may be supplied via a standard AC outlet, power strip, surge protector, and/or Uninterruptible Power Supply (UPS) device.

In some embodiments, the communication device 514 may comprise any type or configuration of communication device that is or becomes known or practicable. The communication device 514 may, for example, comprise a Network Interface Card (NIC), a telephonic device, a cellular network device, a router, a hub, a modem, and/or a communications port or cable. In some embodiments, the communication device 514 may be coupled to receive user and/or player input data, e.g., from a user device (not shown in FIG. 5). The communication device 514 may, for example, comprise a Bluetooth® Low Energy (BLE) and/or RF receiver device that acquires data from a user/player (not separately depicted in FIG. 5) and/or a transmitter device that provides the data to a remote server and/or server or communications layer (also not separately shown in FIG. 5). According to some embodiments, the communication device 514 may also or alternatively be coupled to the processor 512. In some embodiments, the communication device 514 may comprise an infrared (IR), RF, Bluetooth™, NFC, and/or Wi-Fi® network device coupled to facilitate communications between the processor 512 and another device (such as a remote server device, not separately shown in FIG. 5).

In some embodiments, the input device 516 and/or the output device 518 are communicatively coupled to the processor 512 (e.g., via wired and/or wireless connections and/or pathways) and they may generally comprise any types or configurations of input and output components and/or devices that are or become known, respectively. The input device 516 may comprise, for example, a keyboard that allows an operator of the apparatus 510 to interface with the apparatus 510 (e.g., by a table game dealer/manager). The output device 518 may, according to some embodiments, comprise a display screen and/or other practicable output component and/or device. The output device 518 may, for example, provide an interface via which functionality for passive NFC-enabled gaming transactions is provided to a user/player (e.g., via a website and/or mobile device application). According to some embodiments, the input device 516 and/or the output device 518 may comprise and/or be embodied in a single device, such as a touch-screen monitor.

The memory device 540 may comprise any appropriate information storage device that is or becomes known or available, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of table game instructions 542-1, RFID chip instructions 542-2, NFC tag instructions 542-3, interface instructions 542-4, chip data 544-1, NFC tag data 544-2, player data 544-3, and/or game data 544-4. In some embodiments, the table game instructions 542-1, RFID chip instructions 542-2, NFC tag instructions 542-3, interface instructions 542-4, chip data 544-1, NFC tag data 544-2, player data 544-3, and/or game data 544-4 may be utilized by the processor 512 to provide output information via the output device 518 and/or the communication device 514. Other types of data may also be stored. For example, in some embodiments offer data may be stored, defining offers output to players and/or accepted by players via NFC tags, and/or one or more of the status of any benefits provided to players as a result of accepted offers and status of commitments agreed to by such players upon accepting offers.

According to some embodiments, the table game instructions 542-1 may be operable to cause the processor 512 to process the chip data 544-1, NFC tag data 544-2, player data 544-3, and/or game data 544-4 in accordance with embodiments as described herein. Chip data 544-1, NFC tag data 544-2, player data 544-3, and/or game data 544-4 received via the input device 516 and/or the communication device 514 may, for example, be analyzed, sorted, filtered, decoded, decompressed, ranked, scored, plotted, and/or otherwise processed by the processor 512 in accordance with the table game instructions 542-1. In some embodiments, chip data 544-1, NFC tag data 544-2, player data 544-3, and/or game data 544-4 may be fed by the processor 512 through one or more mathematical and/or statistical formulas and/or models in accordance with the table game instructions 542-1 to facilitate, execute, conduct, and/or enable one or more table game transactions to define a gaming session, as described herein.

In some embodiments, RFID chip instructions 542-2 may be operable to cause the processor 512 to process the chip data 544-1, NFC tag data 544-2, player data 544-3, and/or game data 544-4 in accordance with embodiments as described herein. Chip data 544-1, NFC tag data 544-2, player data 544-3, and/or game data 544-4 received via the input device 516 and/or the communication device 514 may, for example, be analyzed, sorted, filtered, decoded, decompressed, ranked, scored, plotted, and/or otherwise processed by the processor 512 in accordance with the RFID chip instructions 542-2. In some embodiments, chip data 544-1, NFC tag data 544-2, player data 544-3, and/or game data 544-4 may be fed by the processor 512 through one or more mathematical and/or statistical formulas and/or models in accordance with the RFID chip instructions 542-2 to track, count, sum, cash-in, cash-out, and/or place and/or resolve wagers with respect to a plurality of RFID-enabled “smart” wagering chip and/or tokens, as described herein.

According to some embodiments, the NFC tag instructions 542-3 may be operable to cause the processor 512 to process the chip data 544-1, NFC tag data 544-2, player data 544-3, and/or game data 544-4 in accordance with embodiments as described herein. Chip data 544-1, NFC tag data 544-2, player data 544-3, and/or game data 544-4 received via the input device 516 and/or the communication device 514 may, for example, be analyzed, sorted, filtered, decoded, decompressed, ranked, scored, plotted, and/or otherwise processed by the processor 512 in accordance with the NFC tag instructions 542-3. In some embodiments, chip data 544-1, NFC tag data 544-2, player data 544-3, and/or game data 544-4 may be fed by the processor 512 through one or more mathematical and/or statistical formulas and/or models in accordance with the NFC tag instructions 542-3 to conduct, facilitate, and/or execute one or more passive NFC-enabled gaming transactions, as described herein.

In some embodiments, the interface instructions 542-4 may be operable to cause the processor 512 to process the chip data 544-1, NFC tag data 544-2, player data 544-3, and/or game data 544-4 in accordance with embodiments as described herein. Chip data 544-1, NFC tag data 544-2, player data 544-3, and/or game data 544-4 received via the input device 516 and/or the communication device 514 may, for example, be analyzed, sorted, filtered, decoded, decompressed, ranked, scored, plotted, and/or otherwise processed by the processor 512 in accordance with the interface instructions 542-4. In some embodiments, chip data 544-1, NFC tag data 544-2, player data 544-3, and/or game data 544-4 may be fed by the processor 512 through one or more mathematical and/or statistical formulas and/or models in accordance with the interface instructions 542-4 to generate and/or output various interface instances, notifications, environments, visualizations, and/or other interface and/or input elements, as described herein. In some embodiments, one or more of NFC tag data 544-2, player data 544-3, and/or game data 544-4 may include an indication of offers available for output to players (and, for example, any triggering or qualifying conditions for outputting a given offer to a player), offers output to a particular player, offers accepted by a particular player, and the status of any benefits or commitments defined by a given accepted offer.

According to some embodiments, the apparatus 510 may comprise the cooling device 550. According to some embodiments, the cooling device 550 may be coupled (physically, thermally, and/or electrically) to the processor 512 and/or to the memory device 540. The cooling device 550 may, for example, comprise a fan, heat sink, heat pipe, radiator, cold plate, and/or other cooling component or device or combinations thereof, configured to remove heat from portions or components of the apparatus 510.

Any or all of the exemplary instructions and data types described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated).

Referring to FIG. 6A, FIG. 6B, FIG. 6C, FIG. 6D, and FIG. 6E, perspective diagrams of exemplary data storage devices 640a-e according to some embodiments are shown. The data storage devices 640a-e may, for example, be utilized to store instructions and/or data, such as the table game instructions 542-1, RFID chip instructions 542-2, NFC tag instructions 542-3, interface instructions 542-4, chip data 544-1, NFC tag data 544-2, player data 544-3, and/or game data 544-4, each of which is presented in reference to FIG. 5 herein. In some embodiments, instructions stored on the data storage devices 640a-e may, when executed by a processor, cause the implementation of and/or facilitate the methods/algorithms 400, 700 of FIG. 4 and/or FIG. 7 herein, and/or portions or combinations thereof.

According to some embodiments, the first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-3, a magnetic base layer 646a-4, a contact layer 646a-5, and/or a substrate layer 646a-6. According to some embodiments, a magnetic read head 648a may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 648b disposed and/or coupled to direct a laser beam through the second data storage medium 646b.

In some embodiments, the second data storage device 640b may comprise a CD, CD-ROM, DVD, Blu-Ray™ Disc, and/or other type of optically-encoded disk and/or other storage medium that is or becomes known or practicable. In some embodiments, the third data storage device 640c may comprise a USB keyfob, dongle, and/or other type of flash memory data storage device that is or becomes know or practicable. In some embodiments, the fourth data storage device 640d may comprise RAM of any type, quantity, and/or configuration that is or becomes practicable and/or desirable. In some embodiments, the fourth data storage device 640d may comprise an off-chip cache, such as a Level 2 (L2) cache memory device. According to some embodiments, the fifth data storage device 640e may comprise an on-chip memory device, such as a Level 1 (L1) cache memory device.

The data storage devices 640a-e depicted in FIG. 6A, FIG. 6B, FIG. 6C, FIG. 6D, and FIG. 6E are representative of a class and/or subset of computer-readable media that are defined herein as “computer-readable memory” (e.g., non-transitory memory devices as opposed to transmission devices or media). The data storage devices 640a-e may generally store program instructions, algorithms, software engines, code, models, and/or modules that, when executed by a processing device cause a particular machine to function in accordance with one or more embodiments described herein.

With reference to FIG. 7, for example, the data storage devices 640a-e may store and/or define an algorithm 700. The algorithm 700 may comprise, for example, one or more software programs, modules, models, engines, and/or applications coded to perform the method 400 of FIG. 4 herein, and/or portions thereof. The algorithm 700, and any reference to the term “algorithm” herein, refers to any set of defined instructions that operate upon input to define and/or provide output. The algorithm 700 may, for example, be specifically programmed and/or otherwise defined to instruct a computer or other device (not shown; e.g., the apparatus 510 of FIG. 5 herein) to solve a particular problem (e.g., logical) and/or resolve a particular mathematical calculation (e.g., arithmetic). In some embodiments, the algorithm 700 may be written and/or defined as a series or sequence of instructions encoded in (e.g., written in accordance with syntax and/or semantics rules) a particular computer programming language (e.g., Python™, Java™, JavaScript™, C, C++, C #, Basic™, FORTRAN, COBOL, Ruby™, and/or Perl™), e.g., a set of instructions that convert and/or encode characters, objects, and/or other data elements into machine code (e.g., code operable to be executed by an electronic processing device such as a CPU). According to some embodiments, the term “model” may refer to one or more algorithms that are coded and/or structured to utilize programming concepts and language elements to describe, represent, predict, analyze, and/or otherwise process data related to a particular problem. In some embodiments, a “model” may be specifically directed to interpreting, simulating, and/or representing a physical, mathematical, and/or computing system component, event, and/or solution. For example, a “wagering model” may comprise one or more programmed algorithms that are directed to simulating likely events in the physical world—e.g., wagering events.

According to some embodiments, the algorithm 700 may comprise soliciting input, at 702. Input from one or more sources may be searched for and/or queried, by structuring and/or executing a database query and/or by sending a data communication signal or “handshake”, such as is common with Bluetooth® short-range communication protocols. In some embodiments, the algorithm 700 may comprise receiving the input, at 704. Whether solicited or otherwise provided and/or acquired (e.g., loaded and/or downloaded), for example, the input for the algorithm 700 may be received, identified, and/or otherwise processed and/or located. According to some embodiments, the algorithm 700 may comprise data processing, at 712. The data processing 712 may, for example, comprise execution of one or more logical and/or computational procedures, modules, models, scripts, and/or routines that may be stored in a memory device 740 (e.g., similar to the data storage devices 640a-e) as a set of instructions or rules 742 and/or that may defined and/or implemented by one or more electrical, mechanical, and/or physical components, such as logic gates, diodes, transistors, relays, and/or switches (e.g., operable to execute the method 400 of FIG. 4 herein, and/or portions thereof).

In some embodiments, execution of the algorithm 700 may comprise a loading of the rules 742 into the memory device 740 and/or into an electronic processing system (not shown) and/or an activation of one or more logic gates and/or other electrical and/or mechanical components. The algorithm 700 may operate upon the input in accordance with the rules 742 to achieve a result by defining output, at 718. The algorithm 700 may, for example, generate, produce, define, identify, calculate, and/or otherwise compute output based on an application of the data processing 712 utilizing the rules 742 and any or all input received at 704. According to some embodiments, the algorithm 700 may comprise providing the output, at 720. One or more output devices (not shown) may be utilized to convey the output (e.g., a result, conclusion, decision, etc.) to one or more other devices and/or entities (not shown), such as one or more users, players, consumers, customers, potential customers, and/or devices utilized thereby. The output may be displayed via an electronic display screen of a computer, mobile/smart phone, smart watch, etc., and/or may be transmitted as one or more electronic signals to one or more network destination addresses, such as e-mail addresses, URL locations, MAC addresses, and/or broadcast radio frequencies.

According to some embodiments, the data processing at 712 may comprise execution of a listing, sequence, matrix, and/or other set of stored steps and/or instructions that utilize the input to define the output. In some embodiments, the listing of steps and/or instruction details may comprise elements that are known to those skilled in the art. The algorithm 700 may partially or completely comprise, for example, instructions and/or steps that are well known, such as steps and/or instructions operable to calculate an area (length times width), volume (length times width times height), distance (difference between two locations), velocity (distance over time), acceleration (velocity over time), and/or any other known mathematical and/or logical (if/then statements) procedures. For any and all known procedures and/or instructions, the discrete details of such instructions are represented by the data processing at 712 and are not listed herein as one of ordinary skill in the art would readily comprehend both what such technological knowledge entails and that the inventor has possession of such knowledge. Instructions that may be included within and/or comprise the data processing at 712 (and/or the algorithm 700) may include, for example, but are not limited to, any known or practicable: (i) OCR algorithms, (ii) GUI object behavior algorithms, (iii) data transmission algorithms, (iv) data encoding algorithms, (v) data decoding algorithms, (vii) logical and/or mathematical data comparison algorithms, (viii) data searching (e.g., keyword searching) algorithms, and/or (ix) any algorithms developed by (e.g., as a result of) application of training data sets to “teach” an AI/ML model how to process data.

Referring now to FIG. 8, illustrated therein is illustrates one example design of a NFC tag package 80 in accordance with some embodiments. The NFC tag package 80 may comprise, for example, a location device 104a-n (FIG. 1), an NFC tag 204a-e (FIG. 2A), and/or be placed in or on a layer of a table system under the felt in an NFC area 254a-e (FIG. 2B). The NFC tag package 80 may comprise multiple layers or features to make it compatible or suitable for use on a gaming table and the challenges of a table game environment. For example, there may be concerns with operating the NFC or combination tags among, or attaching them to, shielding material such as metal and/or from minimizing static or electrical damage. For example, as illustrated and described in more detail with regard to FIG. 2A, in some embodiments a gaming table may include, in a layer under the felt top layer, metal (e.g., aluminum) shielding elements between bet spots, so as to minimize risk of false or unwanted recognition, reading or “acquiring” by an RFID interrogator or antenna of the table of RFID-enabled wagering chips that are not being wagered, such as ones comprising a player bankroll and placed near (but not on) a bet spot at a player position. In the example of FIG. 8, the NFC tag package comprises: (i) an NFC inlay 81; (ii) a ferrite layer 82 between the internal NFC inlay and the aluminum, to optimize performance when the combination tag is installed on a metal surface and/or in an environment that includes metal shields to minimize unintentional readings of wagering chips such as bankrolls, (iii) an aluminum layer or casing 83 to provide shielding (e.g., a 1 mm aluminum shield layer); and (iv) a covering or other layer to protect against static/electrical damage (e.g., Kapton® Tape). In some embodiments, the NFC inlay layer 81 may include an opening, depression or other feature for receiving another element, such as an integrated circuit chip (the depression allowing for the integrated circuit chip to be flush with the surface of the layer 81 once it is inserted).

Referring now to FIG. 9, a flow diagram of a method 900 according to some embodiments is shown. Process 900 is an example process for how an NFC tag package may be registered as corresponding to a particular player position at a particular gaming table within a wagering establishment. In some embodiments, the method 900 may be performed and/or implemented by and/or otherwise associated with one or more specialized and/or specially-programmed computers (e.g., one or more of the user devices 102a-n, 202, the gaming server/casino controller 110a, 210a, the table systems/dealer device 110b, 210b, 300 and/or the apparatus 510 of FIG. 1, FIG. 2A, FIG. 3, and/or FIG. 5 herein), computer terminals, computer servers, computer systems and/or networks, and/or any combinations thereof (e.g., by one or more multi-threaded and/or multi-core processing units of a passive NFC-enabled gaming system). In some embodiments, the method 400 may be embodied in, facilitated by, and/or otherwise associated with various input mechanisms and/or interfaces (such as the interface 520 of FIG. 5 herein).

Process 900 will be described with reference to FIGS. 10A-C, for illustrative purposes only (i.e., process 900 need not utilize GUIs as depicted in FIGS. 10A-10C). FIGS. 10A-C illustrate a example interfaces that may be output to users comprising personnel, agents or representatives of a wagering establishment (“Casino Admins”).

As a preliminary matter, it should be noted that some embodiments described herein may be implemented by providing an NFC Management App (e.g., a downloadable App for a mobile device) for facilitating (i) the registration of NFC tags positioned on gaming tables within a given wagering establishment system, and/or (ii) players to “clock in” and/or participate in gaming transactions using such NFC tags positioned on gaming tables. Such an NFC Management App may be developed and provided for download into user devices (e.g., a user device of a Casino Admin and/or a player) by a manufacturer, distributor or licensee of the gaming table systems on which the NFC tag functionality described herein is available. In accordance with some embodiments, the NFC Management App may include a wagering establishment portal or platform, via which Casino Admins may sign in to the system and obtain access to functionality for Casino Admins. For example, a Casino Admin may utilize the NFC Management App to initially register a particular NFC tag as part of the system, associate it with a particular table in a particular pit or other location of a wagering establishment or confirm its status or proper working order. Similarly, the NFC Management App may include a player portal or platform, via which individuals playing wagering games at gaming tables (“players”) may sign in to the system to access functionality for players (e.g., clock-in as currently playing a wagering game at a particular player position of a particular gaming table, accept an offer, or initiate a gaming transaction, all using the NFC functionality described herein). In some embodiments, two distinct Apps (one for Casino Admins and another for players) may be offered/utilized. The process 900 (FIG. 9), GUIs 10A-C (FIGS. 10A-C), process 1100 (FIG. 11) and GUIs 12A-C (FIGS. 12A-C) assume that a first App, NFC Management App is made available for Casino Admins and a second App, a Player App for players is utilized, in accordance with some embodiments.

In accordance with some embodiments, an NFC Management App (whether the Casino Admin App or the Player App, or both) may allow for communication of data to/from a remote server of a service that provides or manages the NFC Management App and the NFC tag and/or player data collected thereby (e.g., a service that operates or manages a system, such as system 100 of FIG. 1 and/or system 510 of FIG. 5). In some embodiments, the system that receives data from the NFC Management App may be involved with (e.g., control or have a business relationship with an entity that so controls) the manufacturing and/or distribution of the gaming tables and/or NFC tags as described herein and store records of UUIDs of NFC tags that were manufactured and/or included on gaming tables in accordance with embodiments described herein. In some embodiments, data collected via an NFC Management App may be cached and stored in local memory when the device on which the App is downloaded is not able to communicate with the system that is to receive data therefrom (e.g., when the device is not connected to Wi-Fi or does not have a sufficient cellular service connection) and then transfer the data to the system once a sufficient communication connection is established. In accordance with some embodiments, the system may open a record in a database for each gaming table that is manufactured and/or NFC tag that is installed on, or affixed to, a gaming table in accordance with embodiments described herein. In some embodiments, the system may store in that record the UUID of the NFC tag, along with other information corresponding to that NFC tag over time (e.g., a current status, an indication of the gaming table and player position at which it is placed and registered).

Turning now to FIG. 9 and process 900, the NFC tag registration process begins at 902 when a user comprising a Casino Admin enters their login credentials into the NFC Management App (e.g., on their mobile device or other device that includes the appropriate NFC hardware/software). Once logged in, the Casino Admin may be presented with a menu of options, such as that illustrated in example GUI 1000A (FIG. 10A). In the example of FIG. 10A, the menu of options includes functions such as “Search Player” (which may allow the Casino Admin to search for records of different players registered with the system), “Register New Player” (which may allow the Casino Admin to register a new player with the system) and “Register NFC Tags” (which allows the Casino Admin to register one or more NFC tags as being associated with a particular table and player position thereof. In other embodiments, other menu options or functionality may be output. For example, a “Validate” menu option may allow the Casino Admin to validate the registration or proper functioning of a given NFC tag, or a “Deregister” menu option may allow the Casino Admin to deregister one or more NFC tags (e.g., when NFC tags are being moved to a different table, being replaced, being decommissioned, etc.). Assuming the Casino Admin selects the “Register” option (904), the process continues to step 906 in which the Casino Admin is presented with a new GUI that prompts him/her to select certain information. The example GUI 1000B (FIG. 10B) prompts the Casino Admin to indicate information identifying a location of one or more NFC tags to be registered, such as the particular Site (e.g., wagering establishment location), Gaming Area (e.g., area of a wagering establishment, such as a room or section), the Operating Area (which may be a further subdivision of the Gaming Area), Pit (an area of gaming tables), and specific Table (e.g., to indicate the unique number or other identifier of the gaming table at which the relevant NFC tag(s) are located). Once the Casino Admin has entered this information, he/she is prompted to bring the user device close to the NFC tag(s) being registered and, on a GUI such as the example GUI 1000C (FIG. 10C), select the particular player positions of the table selected on the prior GUI for which NFC tags are to be registered. The Casino Admin may then be promoted to scan the NFC tag of each selected position in a particular order (e.g., starting from the smallest-numbered position to the largest-numbered position, if more than one player position was selected). The Casino Admin then proceeds to scan the NFC tags as directed (908). Once the NFC tags are successfully scanned and registered, a GUI or message may be output to the Casino Admin via the user device to indicate this (e.g., a screen with a green checkmark or message of “NFC tag(s) successfully registered” or similar message may be output). If any of the NFC tags at any of the player positions selected are not successfully registered, the Casino Admin may be prompted to redo one or more of the above steps or the scan of a particular NFC chip, or an error message may be output to the Casino Admin. For example, if no NFC tag is detected at a particular player position, the scan attempt may be determined to “time out” and an error message may be output or the user may be requested to restart the scan of the NFC tag at that player position. Once the NFC tags are successfully registered, as indicated by information output to the Casino Admin, the user may be prompted to confirm that the registration process has been completed and/or select “Done” or similar input.

As described with reference to step 404 of FIG. 4, once the Casino Admin enters certain information during the NFC tag registration process 900 (e.g., the information indicated in step 908), the system with which the NFC Management App is communicating (e.g., system 100 of FIG. 1, system 200 of FIG. 2A, or system 510 of FIG. 5), certain data may be stored and/or updated in one or more records or a database. For example, the UUID of a given scanned NFC tag may be stored in association with the table game identifier and specific player position selected by the Casino Admin when registering that NFC tag.

Turning now to FIG. 11, illustrated therein a flow diagram of a method 1100 according to some embodiments is shown. Process 1100 is an example process for how player may clock-in at a particular player position using the NFC tag registered as corresponding to that player position. As described herein, storing the fact that a particular player has clocked in at a particular player position will allow the system to facilitate gaming transactions for that player merely by having the player again tap the NFC tag of that player position in order to effectuate those gaming transactions once the player is so clocked in. For example, the player may order products or services (e.g., drinks, food, etc.) be brought to him/her at that player position merely by tapping his phone to the NFC tag. In another example, the player may accept an offer output to the player (e.g., via a display on the gaming table at that player position, or via an App on the player's mobile device) by tapping his/her phone to the NFC tag after receiving the offer.

In some embodiments, the method 1100 may be performed and/or implemented by and/or otherwise associated with one or more specialized and/or specially-programmed computers (e.g., one or more of the user devices 102a-n, 202, the gaming server/casino controller 110a, 210a, the table systems/dealer device 110b,210b, 300 and/or the apparatus 510 of FIG. 1, FIG. 2A, FIG. 3, and/or FIG. 5 herein), computer terminals, computer servers, computer systems and/or networks, and/or any combinations thereof (e.g., by one or more multi-threaded and/or multi-core processing units of a passive NFC-enabled gaming system). In some embodiments, the method 400 may be embodied in, facilitated by, and/or otherwise associated with various input mechanisms and/or interfaces (such as the interface 520 of FIG. 5 herein).

Process 1100 will be described with reference to FIGS. 12A-C, for illustrative purposes only (i.e., process 1100 need not utilize GUIs as depicted in FIGS. 12A-C). FIGS. 12A-C illustrate example interfaces that may be output to users comprising players, as carried out by an NFC Management App comprising an NFC Player App. In some embodiments, the NFC Player App may be part of a larger scoped App that allows the player to perform other functionality (e.g., access a financial account or player loyalty account, view online gaming progress, view maps or other information of a wagering establishment, etc.). In some embodiments, the NFC Player App may be specific to a particular wagering establishment.

Turning now to process 1100, the player first logs in to the NFC Player App by providing his unique login credentials (1102). For example, the player may utilize GUI 1205 (FIG. 12A). Once logged in, the player may be prompted (1104) to bring his mobile device close to, or to tap, the NFC tag at the player position at which he/she is currently playing (e.g., near an NFC tag position 254a of FIG. 2B). See, for example, GUI 1200B (FIG. 12B). The mobile device will then scan the NFC tag, and if it successfully recognizes the NFC tag and the system recognizes the NFC tag as being previously registered to a player position, the player will be clocked-in as currently playing at that player position of that specific table. Steps 406-408 of FIG. 4 describe what the system may be doing as part of this clocking in process. Once the player is successfully clocked in, a message indicating this may be output to the player and in some embodiments the player may be prompted to confirm the date/time and/or other information (1106). GUI 1200C (FIG. 12C) illustrates an example of a screen that may be output to the player.

As described herein, once the player clocks in using an NFC tag at a particular player position of a gaming table and is therefore associated by the wagering establishment system as currently playing at that player position (e.g., by having such information recorded in the NFC tag data 544-2 and/or player data 544-3), the wagering establishment may utilize this data to facilitate gaming transactions involving the player. For example, the player may tap his mobile phone to the NFC tag corresponding to the player position at which he/she is playing in order to place orders, request assistance, accept an offer, lodge a complaint or alert, etc. When the player taps the NFC tag after clocking in, the system will recognize the player's ID (or the ID of the player's mobile device) upon receiving an input at that NFC tag, and thereby be able to facilitate a response or process the appropriate transaction via other data associated with the player. For example, the player's credit card or other financial account may be charged for products or services the player orders, the player's account may be credited with financial value corresponding to a benefit defined by an offer the player has accepted. The system may likewise direct casino personnel to the player by knowing the player's exact position based on the NFC chip the player tapped. For example, the system may prompt the dealer to provide promotional currency in the form of wagering chips if that is the benefit defined by an offer the player accepted. In another example, the system may direct a waitress to bring a drink to the player's position if that is the product the player ordered.

### V. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

As used herein, the terms “bet spot” or a “wager placement position”, whether physical or virtual, refers to an area of a game table or an area of a virtual game representation (e.g., a graphical representation of a virtual table) on which a representation or indication of a wager may be placed or output. Thus, for example, a bet spot or wager placement position may comprise a specifically designated or identifiable area on which a person (e.g., player or dealer) may place at least one gaming element (e.g., a wagering chip or token) to indicate placement of a wager. It should further be noted that a gaming element may be a physical wagering element (e.g., a physical wagering chip, in the context of a physical table) or a virtual wagering element (e.g., a graphical representation of a wagering chip, as may be depicted on a graphical representation of a virtual table). In some embodiments, reference is made to “wagering chips” which reference should be understood to refer to either physical wagering chips or virtual wagering chips, depending on the context. Although at times embodiments are described with reference to wagering chips, such embodiments can also be implemented using other types of gaming elements (e.g., tokens, lammers, etc.) useful for indicating placement of a wager and the embodiments described herein are not dependent on any particular form of gaming element for indicating placement of a wager.

Some embodiments described herein are associated with a “user device”, a “player device”, or a “network device”. As used herein, the terms “user device”, “player device”, and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (Dec. 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The indefinite articles “a” and “an,” as used herein in the specification and in the claims, unless clearly indicated to the contrary, should be understood to mean “at least one.” This rule applies even within the body of a claim where a first instance of an element utilizes “a” or “an” and a second or subsequent instance of the element necessarily utilizes (e.g., for purposes of proper grammar and required antecedent basis) the definite article “the” to refer to the element. The use of the definite article “the” does not limit the element to a single object merely because it is utilized to refer back to a previous mention of the element. The original reference to the element controls with respect to the plurality (or lack thereof) of the element.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. An NFC-enabled table system for facilitating a wagering game, comprising:
a plurality of wagering tables, each wagering table comprising a table surface defining a plurality of player position areas, and wherein each of the player position areas comprises a unique NFC tag having a Unique Tag IDentifier (UTID);
a database defining a plurality of records, each record corresponding to a respective UTID of an NFC tag, a unique table identifier of the wagering table at which the NFC tag is located and the corresponding player position area at which the NFC tag is located;
a processing device in communication with the database; and
a non-transitory memory device in communication with the processing device, the memory device storing instructions that when executed by the processing device, result in:
receiving, by the processing device, an indication that a player has scanned a particular NFC tag at the wagering table at a first time, the indication comprising the UTID of the particular NFC tag and a unique player identifier of the player;
determining, by the processing device querying the database, a particular wagering table and a particular player position area at which the player scanned the particular NFC tag, thereby identifying an activated wagering table and an activated player position area;
outputting to the player, via a player App on a mobile device of the player and responsive to the received indication that the player scanned the particular NFC tag at the first time, an indication of (i) the first time; (ii) the activated wagering table and the activated player position area; and (iii) a clocking-in request;
receiving, from the player and via the App, a first confirmation that the indication of (i)-(iii) is correct; and
clocking the player in as having initiated a wagering session specific to the activated player position area at the activated wagering table at the first time, responsive to the received first confirmation;
tracking wagering activity of the player at the activated wagering table and the activated player position during the wagering session;
receiving from the player a request to end the wagering session at a second time; and
clocking the player out as having ended the wagering session specific to the activated player position area at the active wagering table at a second time, responsive to the received request.

2. The system of claim 1, wherein receiving from the player the request to end the wagering session at the second time comprises:
receiving, by the processing device, an indication that the player has scanned the particular NFC tag at a second time that is later than the first time;
outputting to the player, via the player App, an indication of (iv) the second time; and (v) a clocking-out request; and
receiving, from the player and via the App, a second confirmation that the indication of (iv) and (v) is correct

3. The system of claim 1, wherein the activated wagering table comprises a dealer display for outputting instructions to a dealer of the particular wagering table, and wherein instructions, when executed by the processing device, further result in:
retrieving, by the processing device and based on the player identifier, an image; and
outputting, via the dealer display, the image and a prompt for the dealer to confirm that the player present at the activated player position area matches the image.

4. The system of claim 1, wherein the remote transaction device comprises the activated wagering table.

5. The system of claim 4, wherein the activated player position area comprises a bet position defining a specific bet available at the activated wagering table, and wherein the gaming transaction comprises automatically placing an instance of the specific bet on behalf of the player for the next game session to be played at the activated wagering table.

6. The system of claim 1, wherein the remote transaction device comprises a POS device in a casino.

7. The system of claim 6, wherein the wherein the gaming transaction comprises a purchase order for a product to be delivered to the activated player position area.

8. The system of claim 1, wherein the gaming transaction comprises an offer that has been output to, and accepted by the player.

9. The system of claim 1, wherein causing the remote transaction device to initiate a gaming transaction, the gaming transaction being specific to the activated player position area, comprises causing promotional currency to be issued to the player, the promotional currency being a benefit defined by the offer accepted by the player.

10. An NFC-enabled table system for facilitating a wagering game, comprising:
a plurality of wagering tables, each wagering table comprising a table surface defining a plurality of player position areas, and wherein each of the player position areas comprises a unique NFC tag having a Unique Tag IDentifier (UTID);
a database defining a plurality of records, each record corresponding to a unique table identifier of one wagering table of the plurality of wagering tables, and a plurality of player positions available on that one wagering table;
a processing device in communication with the database; and
a non-transitory memory device in communication with the processing device, the memory device storing instructions that when executed by the processing device, result in:
receiving, by the processing device, an indication that a user has selected, via a software app on a mobile device, the one wagering table and one specific player position of the plurality of player positions available on the one wagering table along with a request to register an NFC tag as being associated therewith;
prompting the user to scan the NFC tag;
receiving, from a scan of the particular NFC tag, an indication comprising the UTID of the particular NFC tag; and
registering the NFC tag, including an indication of the UTID, as corresponding to the one specific player position of the one wagering table.

11. The system of claim 10, wherein the memory device stores further instructions that when executed by the processing device further result in:
receiving, from a player and via a software app of the player's mobile device, an indication of the UTID of the NFC tag;
receiving at least one of a unique identifier of the player and a unique identifier of the player's mobile device; and
storing in a database an indication that the player is currently participating in a wagering game at the one wagering table and at the specific player position corresponding to the UTID.

12. The system of claim 11, wherein the memory device stores further instructions that when executed by the processing device further result in:
tracking game play of the player;
determining, based on the game play, that the player has qualified for an offer defining a benefit in exchange for agreeing to a commitment;
outputting, to the player via the player's mobile device, the offer;
determining, after outputting the offer, that the player has scanned the NFC tag, thereby determining that the player has accepted the offer

13. The system of claim 12, wherein the memory device stores further instructions that when executed by the processing device further result in:
transmitting a command signal to a remote device, the command signal being operable to cause the benefit to be provided to the player.

14. The system of claim 13, wherein the remote device comprises a dealer display of the one wagering table, the benefit defined by the offer comprises a specified value of wagering chips, and the command signal comprises instructions for the dealer to provide the specified value of wagering chips to the player at the specific player position.
